(19) United States
(12) Patent Application Publication
(10) Pub. No.: US 2014/0003427 A1
(43) Pub. Date: Jan. 2, 2014

(54) NETWORK SYSTEM, AND MANAGEMENT APPARATUS AND SWITCH THEREOF

(71) Applicant: HITACHI, LTD, Tokyo (JP)

(72) Inventors: Yusuke NISHI, Yokohama (JP); Masayuki SAKATA, Kirkland, WA (US); Junji KINOSHITA, Yokohama (JP); Osamu TAKADA, Kamakura (JP)

(73) Assignee: HITACHI, LTD, Tokyo (JP)

(21) Appl. No.: 13/892,825

(22) Filed: May 13, 2013

(30) Foreign Application Priority Data
Jun. 27, 2012 (JP) 2012-143684

(51) Int. Cl. H04L 12/761

(52) U.S. Cl. CPC H04L 45/16
USPC 370/390

(57) ABSTRACT

There is provided a management apparatus including a system configuration information management unit that manages coupling of a virtual switch and a network apparatus; a server information management unit that manages a multicast address to be used as a destination address when communication of a virtual server is converted into multicast communication; a multicast tree management unit that calculates a transfer route for a multicast packet on multiple physical routes; and a switch control unit that notifies the virtual switch or the network apparatus of the transfer route for the multicast packet that has been calculated by the multicast tree management unit, and thereby controls the transfer route for the multicast packet.

### INCORPORATION BY REFERENCE

This application claims priority based on Japanese patent application, No. 2012-143684 filed on Jun. 27, 2012, the entire contents of which are incorporated herein by reference.

### BACKGROUND

The subject matter to be disclosed relates to a centralized multicast tree management technique in a network system.

In recent years, a technique for virtualizing computer resources has enabled multiple virtual servers to run on one physical server. A data center has many virtual servers running to thereby accommodate many customer systems, that is, tenants, in the same infrastructure. While each tenant shares network resources, it is desirable to logically partition a network for each tenant, for example, for the purpose of preventing fraudulent interception of data packet.

Non Patent Literature 1 describes a technique for constructing numerous logical s (about 16 million logical networks). According to the technique described in Non Patent Literature 1, a virtual network termination unit is provided in a virtual switch in each physical server or the like, and the virtual network termination unit encapsulates a MAC (Media Access Control) frame into a UDP/IP (User Datagram Protocol/Internet Protocol) packet, and transmits the encapsulated packet to a virtual network termination unit (a destination virtual network termination unit) to which a destination virtual server belongs. In the encapsulation, an identifier for identifying the tenant (a tenant identifier) is added into the packet. When receiving the packet, the destination virtual network termination unit verifies and filters a combination of the tenant identifier and a destination address of the encapsulated MAC frame to logically partition the network for each tenant. Moreover, a multicast frame and a broadcast frame are encapsulated in a multicast packet by the virtual network termination unit. Multicast communication is used between the virtual network termination units to transmit data only to a virtual network termination unit connecting with a virtual server of the same tenant as a source virtual server, and thereby logical network partitioning for each tenant is achieved.

Multicast communication is a technique for concurrently transmitting the same data packet to multiple specific modules. A port that should perform transfer is defined for each multicast address in each switch or router, and thereby a transfer route for the multicast packet, that is, a multicast tree is constructed on the network. IGMP (Internet Group Management Protocol) or IGMP Snooping has been known as one of schemes for controlling the multicast tree. According to IGMP and IGMP Snooping, the switch or the router learns the multicast address for which transfer should be performed and a transfer port, through a query packet from the switch or the router, and an exchange of a participation request packet for the multicast tree from a multicast packet receiving module. All the switches or the routers perform this learning, and thereby the multicast tree for each multicast address is constructed on the network, so that the multicast packet can be transferred only to a module that hopes to receive the multicast packet.

Since the multicast tree constructed according to IGMP and IGMP Snooping does not have a redundant configuration, if a failure occurs in a route, the multicast tree needs to be reconstructed by newly exchanging the query packet and the participation request packet. If there are many modules using the multicast communication, the router or the switch needs to process a large number of participation request packets. The multicast tree is thus not reconstructed before completion of the process, which may lead to a communication failure.

Patent Literature 1 discloses a technique for constructing multiple multicast trees. According to the technique described in Patent Literature 1, adjacent switches or routers notify each other of coupled terminals or currently relayed multicast packets, according to their own protocols. Each of the switches or the routers uses information in the notification to select the switch or the router to which the participation request packet is transmitted. This selection determines the transfer port for the multicast packet in the switch or the router. All the switches or the routers perform this exchange, and thereby the multicast tree is constructed on the network. Moreover, the participation request packet is then extended to provide an identifier to the multicast tree, so that multiple multicast trees can be constructed for the same multicast address.

Furthermore, Patent Literature 2 discloses a technique in which a centralized management apparatus manages network resources related to multicast. According to the technique described in Patent Literature 2, the centralized management apparatus manages a multicast address and a multicast tree for the multicast address. If a module hopes to start multicast communication, the module makes a multicast communication session request to the centralized management apparatus. The centralized management apparatus notifies the module of a multicast address to be used, based on the session request. For the multicast address to be included in the notification, a multicast tree satisfying the session request may have already been constructed, or a multicast tree may have been constructed by the centralized management apparatus newly setting a transfer port for a multicast packet in a switch or a router so that the multicast tree satisfies the session request. Then, routes in the case of no route failure and in the case of a route failure have previously been set in the multicast tree constructed by the centralized management apparatus. While the route in the case of no route failure is normally used, the route in the case of a route failure is used if a failure occurs in the route in the case of no route failure. This achieves redundancy.

### CITATION LIST

[PATENT LITERATURE 1] US 2007/0177594 A1
[PATENT LITERATURE 2] US 2004/0258066 A1
[NON PATENT LITERATURE 1] “A Framework for Overlaying Virtualized Layer 2 Networks over Layer 3 Networks,” [online], 2011 Aug. 26, [retrieved on 2012 May 29], the Internet <URL: http://tools.ietf.org/id/draft-mahalingam-dutt-dcops-vxlan-01.txt>
[NON PATENT LITERATURE 2] “VMware vMotion for Live Migration of Virtual Machines,” [on line], [retrieved on 2012 Jun. 19], the Internet <URL: http://www.vmware.com/products/vmotion/overview.html>

### SUMMARY

The technique described in Patent Literature 1 provides the identifier for the multicast tree to construct multiple multicast trees for each multicast address. However, an increase in the number of multicast addresses to be used for the communication increases the number of multicast trees to be equal to or larger than the number of multicast addresses. Consequently, the switch or the router needs to learn more transfer ports for the multicast packet. The switch or the router has a limited memory for leaning the transfer ports for the multicast packet. This limits the number of available multicast addresses and leads to difficulty in accommodating many tenants in the technique for constructing numerous logical networks.

In the technique described in Patent Literature 2, the multicast address for which the redundant multicast tree satisfying the session request received from the module have been constructed is assigned to the module, through uniform management of the network resources by the centralized management apparatus. In the data center, however, as in Non Patent Literature 2, a virtual server that triggers usage of the multicast communication can migrate between physical servers in the technique for constructing numerous logical networks. In Patent Literature 2, in order for the virtual server to move between the physical servers and perform the multicast communication, it is necessary to make a new session request to the centralized management apparatus after the movement of the virtual server, and wait for assignment of the multicast address. Meanwhile, the virtual server cannot use the multicast communication because of lack of an available multicast address, which may lead to a communication failure.

Accordingly, there is a need for a more improved multicast tree management technique.

In consideration of the above points, the present description discloses a centralized multicast tree management system and a method thereof that can construct many logical networks according to the technique for constructing numerous logical networks and that can continue communication when a route failure occurs or when a virtual server moves between physical servers in a virtualized environment.

The present description includes multiple aspects that achieve the above object, and an example of the aspects is a network system including a plurality of relay switches and a plurality of physical server apparatuses that are coupled via a network, and including a virtual server and a virtual switch that are configured on each of the physical servers, the virtual switch having a function of converting communication of the virtual server into multicast communication, the network system including a management apparatus coupled to the relay switches and the physical server apparatuses via a management network, wherein

the management apparatus performs managing a coupling configuration of each virtual switch and each of the relay switches, a coupling configuration between each of the relay switches, and a coupling configuration of each virtual server and each virtual switch; managing a multicast address to be set as a destination address when a frame transmitted by the virtual server is converted into a multicast packet at the virtual switch; using the coupling configurations and the multicast address to obtain a setting that uses a plurality of routes for constructing one multicast tree on the network; and notifying the virtual switch and/or the relay switch of the obtained setting for constructing the multicast tree, the relay switch performs receiving the notification of the setting for constructing the multicast tree, from the management apparatus; and executing an instruction on the setting, and the virtual switch performs receiving the notification of the setting for constructing the multicast tree, from the management apparatus; and executing the instruction on the setting.

It should be noted that the above setting that uses a plurality of routes for constructing one multicast tree on the network, for example, may be a plurality of settings by way of different switches.

The management apparatus may further be configured to perform, before the virtual server is configured on the physical server, obtaining a setting for constructing a multicast tree to be newly constructed by the configuration of the virtual server; and instructing the virtual switch and/or the relay switch to add the obtained setting.

The management apparatus may further be configured to perform, if a new relay switch is added, obtaining a setting for constructing a new multicast tree by way of the added relay switch; and instructing the virtual switch and/or the relay switch to add the obtained setting.

Furthermore, when the management apparatus notifies the virtual switch or the relay switch of the obtained setting for constructing the multicast tree, the management apparatus may be configured to specify the multicast address, and a port that outputs the multicast packet with the destination address that is the multicast address; if the management apparatus notifies the relay switch of the multicast address, and the port that outputs the multicast packet with the destination address that is the multicast address, when the relay switch outputs the multicast packet with the destination address that is the multicast address, the relay switch may be configured to transmit the multicast packet from the port in the notification; and if the management apparatus notifies the virtual switch of the multicast address, and the port that outputs the multicast packet with the destination address that is the multicast address, when the virtual switch outputs the multicast packet with the destination address that is the multicast address, the virtual switch may be configured to transmit the multicast packet from the port in the notification.

Alternatively, when the management apparatus notifies the virtual switch or the relay switch of the obtained setting for constructing the multicast tree, the management apparatus may be configured to specify a port that outputs a multicast tree construction packet, and instruct the virtual switch using the multicast communication, to transmit the multicast tree construction packet; if the management apparatus notifies the relay switch of the port that outputs the multicast tree construction packet, when the relay switch transfers the multicast tree construction packet that is received, the relay switch may be configured to transmit the received multicast tree construction packet from the port in the notification; if the management apparatus notifies the virtual switch of the port that outputs the multicast tree construction packet, when the virtual switch transfers the multicast tree construction packet that is received, the virtual switch may be configured to transmit the received multicast tree construction packet from the port in the notification; and if the management apparatus instructs the virtual switch to transmit the multicast tree construction packet, the virtual switch may be configured to generate the multicast tree construction packet, and transmit the multicast tree construction packet from the port in the notification.

Furthermore, if the management apparatus instructs the relay switch to transmit the multicast tree construction packet, the relay switch may be configured to generate the multicast tree construction packet, and transmit the multicast tree construction packet from the port in the notification.

According to the above aspects, for example, when a route failure occurs or when a virtual server that performs multicast communication moves to another physical server, the communication can be performed without reconstruction of the multicast tree.

According to the disclosure, a multicast tree management technique can be provided which can construct many logical networks with fewer communication failures.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWING

FIG. 1 illustrates a configuration of a network system, in relation to a first embodiment and a second embodiment;

FIG. 2 illustrates a functional configuration of a management apparatus, in relation to the first embodiment and the second embodiment;

FIG. 3 illustrates a functional configuration of a relay switch, in relation to the first embodiment;

FIG. 4 illustrates a configuration of a physical server, in relation to the first embodiment;

FIG. 5 illustrates a configuration of a system configuration information management table retained by the management apparatus, in relation to the first embodiment and the second embodiment;

FIG. 6 illustrates a configuration of a virtual server management table retained by the management apparatus, in relation to the first embodiment and the second embodiment;

FIG. 7 illustrates a configuration of a multicast tree configuration management table retained by the management apparatus, in relation to the first embodiment and the second embodiment;

FIG. 8A illustrates a configuration of a multicast packet-transfer route table retained by the relay switch, in relation to the first embodiment and the second embodiment;

FIG. 8B illustrates a configuration of a multicast packet-transfer route table retained by a virtual switch, in relation to the first embodiment and the second embodiment;

FIG. 9 is a block diagram illustrating a packet format of a multicast tree setting packet to be transmitted to the relay switch and the virtual switch by the management apparatus, in relation to the first embodiment;

FIG. 10 illustrates a sequence of communication when a virtual server moves between physical servers, in relation to the first embodiment;

FIG. 11 illustrates a sequence of communication when the relay switch is added, in relation to the first embodiment;

FIG. 12 is a flowchart illustrating a processing procedure in the management apparatus to calculate a multicast tree and to notify the relay switch or the virtual switch of a transfer route for a multicast packet, when the virtual server moves between the physical servers, in relation to the first embodiment;

FIG. 13 is a flowchart illustrating a processing procedure in the management apparatus to select a multicast packet transfer port in the relay switch and the virtual switch, in relation to the first embodiment;

FIG. 14 is a flowchart illustrating a processing procedure in the management apparatus to update the multicast tree configuration management table, and to transmit the multicast tree setting packet, in relation to the first embodiment;

FIG. 15 is a flowchart illustrating a processing procedure to update the multicast packet-transfer route table in the relay switch and the virtual switch, in relation to the first embodiment;

FIG. 16 is a flowchart illustrating a processing procedure in the management apparatus to calculate the multicast tree, and to notify the relay switch or the virtual switch of the transfer route for the multicast packet, when the relay switch is added, in relation to the first embodiment;

FIG. 17 illustrates a configuration of the relay switch, in relation to the second embodiment;

FIG. 18 illustrates a configuration of the physical server, in relation to the second embodiment;

FIG. 19A illustrates a configuration of a multicast tree construction packet-transfer route table retained by the relay switch, in relation to the second embodiment;

FIG. 19B illustrates a configuration of a multicast tree construction packet-transfer route table retained by the virtual switch, in relation to the second embodiment;

FIG. 20 is a block diagram illustrating a packet format of a multicast tree construction packet-transfer route setting packet to be transmitted to the relay switch and the virtual switch by the management apparatus, in relation to the second embodiment;

FIG. 21 is a block diagram illustrating a packet format of a multicast tree construction packet-transmission instruction packet to be transmitted to the relay switch and the virtual switch by the management apparatus, in relation to the second embodiment;

FIG. 22 illustrates the sequence of communication when the virtual server moves between the physical servers, in relation to the second embodiment;

FIG. 23 illustrates the sequence of communication when the relay switch is added, in relation to the second embodiment;

FIG. 24 is a flowchart illustrating the processing procedure in the management apparatus to update the multicast tree configuration management table, and to transmit the multicast tree setting packet, in relation to the second embodiment;

FIG. 25 is a flowchart illustrating a processing procedure to update the multicast tree construction packet-transfer route table in the relay switch or the virtual switch, in relation to the second embodiment; and

FIG. 26 is a flowchart illustrating a processing procedure to transmit a multicast tree construction packet in the relay switch or the virtual switch, in relation to the second embodiment.

### DETAILED DESCRIPTION OF THE EMBODIMENTS

Embodiments will be described in detail below with reference to the drawings. It should be noted that the following description is an example, and is not limited to the configurations of examples.

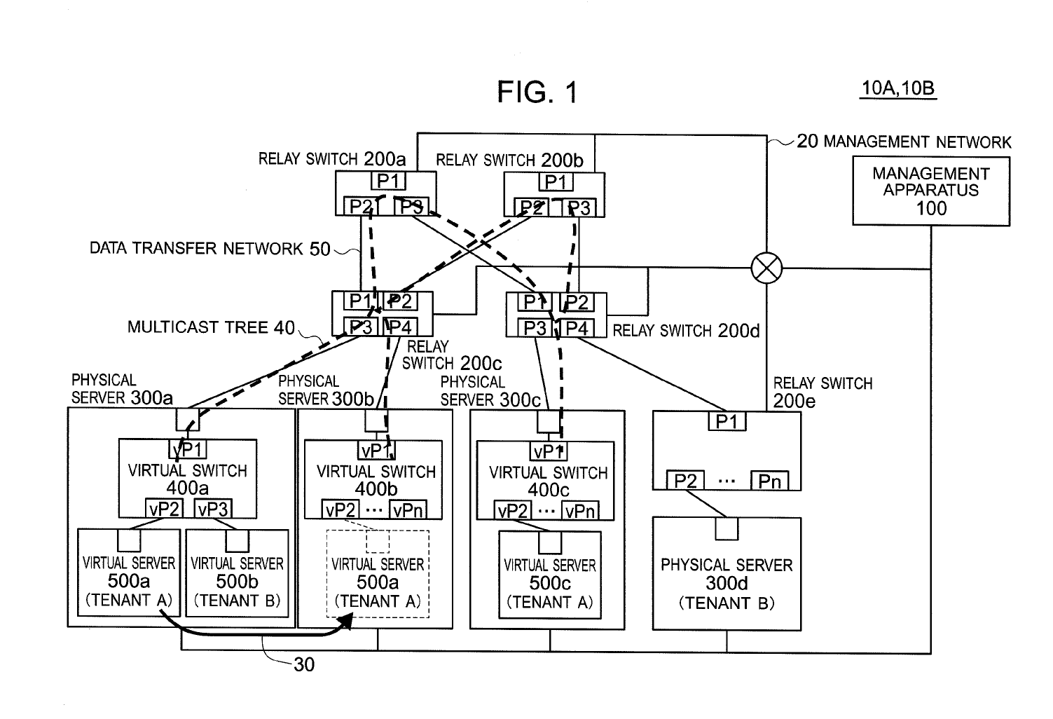

A first embodiment will be described with reference to FIGS. 1 to 16.

FIG. 1 generally illustrates a network system 10A according to the first embodiment.

In the present embodiment, the network system 10A is configured with a management apparatus 100, relay switches 200a to 200e, and physical servers 300a to 300d. The relay switches 200a to 200e are hereinafter referred to as “relay switch 200” if they are not particularly distinguished from one another. The physical servers 300a to 300d are hereinafter referred to as “physical server 300” if they are not particularly distinguished from one another.

The management apparatus 100 is, for example, realized on a computing machine that is physical computer hardware. The management apparatus 100 is coupled to the relay switches 200a to 200e and the physical servers 300a to 300d via a management network 20, and for example, changes a network setting of the relay switch 200 or instructs to move a virtual server between the physical servers 300.

The relay switch 200 is, for example, a layer-2 switch or a layer-3 switch. The relay switches 200a and 200b are coupled to the relay switches 200c and 200d via a network used for transmitting and receiving a frame or a packet. The relay switches 200c and 200d are similarly coupled to the physical servers 300a to 300d via a network used for transmitting and receiving a frame or a packet. Each relay switch 200 determines a transfer route of a received frame or packet to transmit the received frame or packet. Reference characters P1 to P4 in the relay switch 200 denote physical or logical communication ports.

Moreover, in the present example, the relay switch 200e functions as a virtual network termination unit in a technique for constructing numerous logical networks, in relation to communication of the physical server 300d. The relay switch 200e functioning as the virtual network termination unit encapsulates a multicast frame and a broadcast frame received from the physical server 300d, into a multicast packet, based on a table (not shown) including server IDs, tenant IDs and multicast addresses that have previously been registered and associated with one another. The relay switch 200e then transfers the multicast packet to the relay switch 200d.

The physical server 300a includes a virtual switch 400a and virtual servers 500a and 500b, while the physical server 300c includes a virtual switch 400c and a virtual server 500c. The physical server 300b includes a virtual switch 400b. The physical server 300d does not deploy any virtual switch or virtual server, and is assumed to be a physical server used by a tenant B. The virtual switches 400a to 400c are hereinafter referred to as “virtual switch 400” if they are not particularly distinguished from one another. The virtual servers 500a to 500c are hereinafter referred to as “virtual server 500” if they are not particularly distinguished from one another. The physical server 300 is, for example, realized on a computing machine that is physical computer hardware. The physical server 300 is coupled to the management apparatus 100 and the relay switch 200 so as to be mutually communicable via the relay switch 200 or a data transfer network 50.

The virtual switch 400 is realized by a program being executed on the physical server 300, and for example, behaves similarly to the relay switch. The virtual switch 400 is coupled to the virtual server 500, and to the relay switch 200, for example, via a physical MC of the physical server 300. The virtual switch 400 determines a transfer route of a received frame or packet to transmit the received frame or packet. Reference characters vP1 to vP3 in the virtual switch 400 denote logical ports. Moreover, in the present example, the virtual switch 400 functions as the virtual network termination unit in the technique for constructing numerous logical networks, in relation to communication of the virtual server 500. The virtual switch 400 functioning as the virtual network termination unit encapsulates a multicast frame and a broadcast frame received from the virtual server 500, into a multicast packet, based on a table (not shown) including virtual server IDs, tenant IDs and multicast addresses that have previously been registered and associated with one another. The virtual switch 400 then transfers the multicast packet to the relay switch 200.

The virtual server 500 is realized by a program being executed on the physical server 300, and for example, behaves similarly to a computing machine. Any operating system, application program or the like operates on the virtual server 500. The virtual servers 500a, 500b and 500c are assumed to be virtual servers used by a tenant A, by the tenant B, and by the tenant A, respectively.

The management network 20 of FIG. 1 is a network that couples the management apparatus 100 to the relay switch 200 and the physical server 300. The management apparatus 100, for example, transmits a multicast tree setting packet 1, a multicast tree construction packet-transfer route setting packet 2, and a multicast tree construction packet-transmission instruction packet 3, via the management network 20, in order to notify the relay switch 200 or the virtual switch 400 of instructions related to multicast tree construction.

An arrow 30 of FIG. 1 denotes movement of the virtual server 500a from the physical server 300a to the physical server 300b. A multicast tree 40 of FIG. 1 denotes a multicast tree of the tenant A among the virtual network termination units immediately before the movement of the virtual server 500a from the physical server 300a to the physical server 300b.

For example, in the case where the virtual server 500a exists in the physical server 300a, when the virtual server 500c transmits a broadcast frame to the virtual server 500 of the tenant A, this frame is transmitted to the virtual switch 400c, and is encapsulated into a multicast packet with a destination that is a multicast address corresponding to the tenant A, by the function as the virtual network termination unit in the virtual switch 400c. This packet is transmitted from the virtual switch 400c to the relay switch 200d.

In the relay switch 200d, there are communication ports P1 and P2 as two multicast packet transfer ports toward the relay switch 200c. The relay switch 200d selects the transfer port that transmits this packet, for example, by a transfer function in the switch, such as an ECMP (Equal Cost Multi Path) technique. It should be noted that all the transfer ports may then be selected. Here, this packet is assumed to be transferred from the relay switch 200d to the relay switch 200a. This packet is transmitted from the relay switch 200d to the relay switch 200c by way of the relay switch 200a.

The relay switch 200c transfers this packet to the virtual switch 400a and the virtual switch 400b. The virtual switch 400a uses the function as the virtual network termination unit to determine whether or not there is the virtual server 500 of the tenant A to which the packet should be transferred, under the virtual switch 400a. The virtual switch 400a then receives a positive result, decapsulates this packet, and transmits the broadcast frame transmitted by the virtual server 500c, to the virtual server 500a. The virtual switch 400b uses the function as the virtual network termination unit to determine whether or not there is the virtual server 500 of the tenant A to which the packet should be transferred, under the virtual switch 400b. The virtual switch 400b then receives a negative result, and discards this packet.

The data transfer network 50 of FIG. 1 is a network that couples between the relay switches 200, and couples the relay switch 200 to the physical server 300. For example, a data frame or a data packet transmitted by the physical server 300 or the virtual server 500 is transferred to another physical server 300 or another virtual server 500 via the data transfer network 50.

In the present embodiment, the management apparatus 100 is directly coupled to the relay switch 200 and the physical server 300, and the relay switch 200 is directly coupled to the physical server 300. Any switch or repeater, however, may intervene in such coupling.

Moreover, the number of devices in the configuration and the number of coupling links among the devices in the network system of FIG. 1 are just an example, and are not limited to this configuration. Various numbers of devices or coupling links may be used.

The relay switch 200 and the virtual switch 400 are hereinafter simply referred to as “switch” if they are not particularly distinguished from one another. Moreover, the physical server 300 and the virtual server 500 are simply referred to as “server” if they are not particularly distinguished as the computing machines from one another.

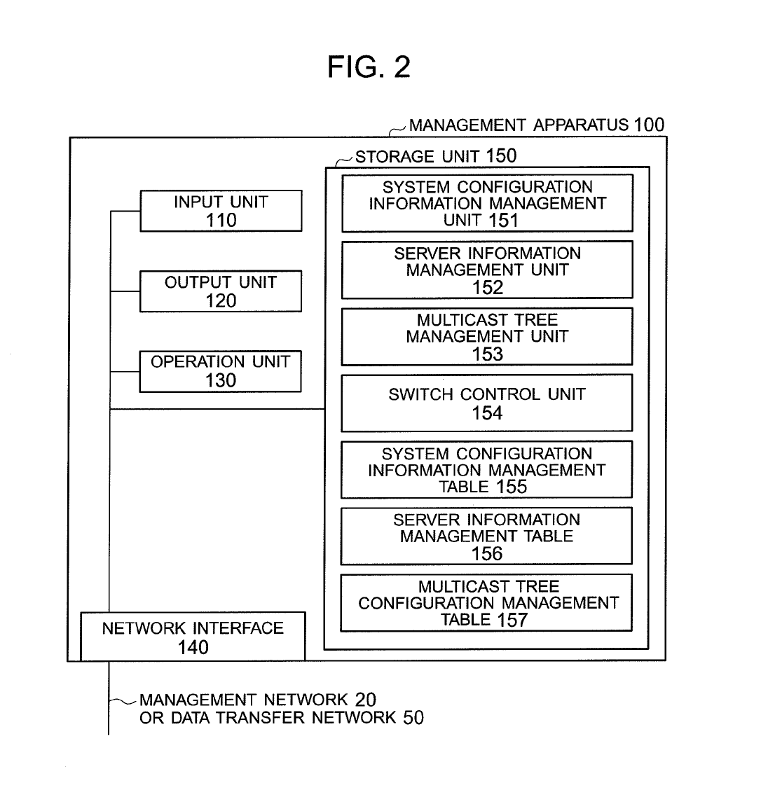

FIG. 2 is a diagram illustrating a functional configuration of the management apparatus 100. The management apparatus 100, for example, includes an input unit 110, an output unit 120, an operation unit 130, a network interface 140, and a storage unit 150.

The input unit 110, for example, transmits user input information inputted from devices such as a keyboard and a mouse, to the operation unit 130.

The output unit 120, for example, notifies a device such as a display of output information for the user input.

The operation unit 130 executes an operating system, programs for realizing processing units to be described below, and the like, which are stored in the storage unit 150.

The network interface 140 is, for example, configured with a device such as an NEC (Network interface Card), and is coupled to other devices.

The storage unit 150 is, for example, a storage device such as a flash memory or an HDD (Hard Disc Drive), and stores the operating system (not shown); the programs for realizing the respective processing units such as a system configuration information management unit 151, a server information management unit 152, a multicast tree management unit 153, and a switch control unit 154; a system configuration information management table 155; a server information management table 156; and a multicast tree configuration management table 157.

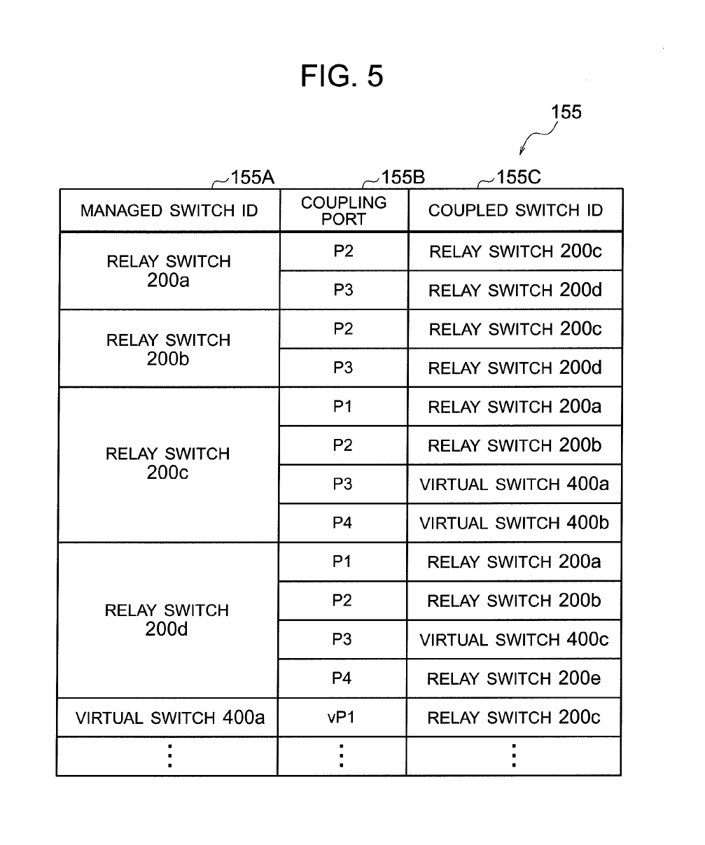

The system configuration information management unit 151, for example, determines to add, delete or move the relay switch 200, the physical server 300, the virtual switch 400, or the virtual server 500, and stores and manages a coupling configuration of the relay switch 200 or the virtual switch 400 in the system configuration information management table 155 illustrated in FIG. 5. Another management system (not shown) that manages each device may determine to add, delete or move the relay switch 200, the physical server 300, the virtual switch 400, or the virtual server 500. The system configuration information management unit 151 then cooperates with another management system to sense the addition, the deletion or the movement of each device, and stores the coupling configuration of the relay switch 200 or the virtual switch 400 in the system configuration information management table 155.

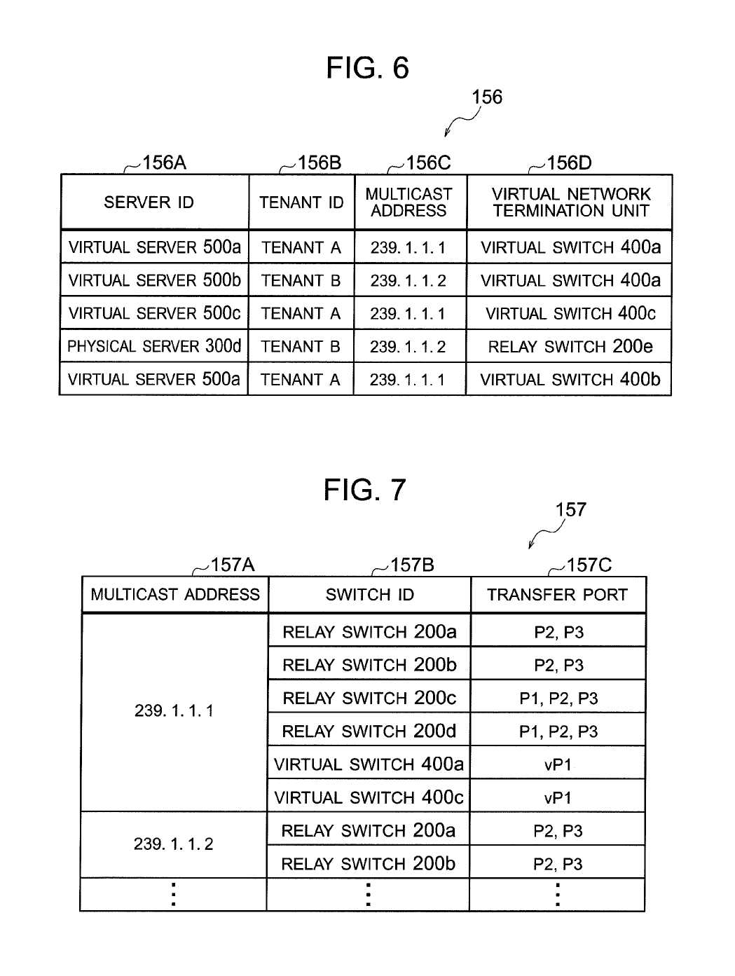

The server information management unit 152 determines a tenant ID corresponding to a server; a multicast address to be set as a destination address when a multicast frame and a broadcast frame to be transmitted by this server are encapsulated at the virtual network termination unit (not shown); and a switch functioning as the virtual network termination unit. The server information management unit 152 then stores and manages them in the server information management table 156 illustrated in FIG. 6.

However, another management system (not shown) may determine the tenant ID corresponding to the server; the multicast address to be set as the destination address during the encapsulation of the frames transmitted by this server; and the switch functioning as the virtual network termination unit. The server information management unit 152 then cooperates with another management system to manage the tenant ID corresponding to the server, the multicast address, and the switch functioning as the virtual network termination unit, and stores them in the server information management table 156.

The multicast tree management unit 153 obtains content of a setting required for constructing a multicast tree for each tenant (that is, a transfer route for a multicast packet), by using the coupling configuration of the relay switch 200 or the virtual switch 400, which is stored in the system configuration information management table 155, as well as the tenant ID of the server and the switch functioning as the virtual network termination unit, which are stored in the server information management table 156. Specifically, the multicast tree management unit 153, for example, obtains the transfer port for the multicast packet toward the multicast address in the relay switch 200 or the virtual switch 400, and stores the transfer port in the multicast tree configuration management table 157 illustrated in FIG. 7.

The switch control unit 154 notifies the relay switch 200 or the virtual switch 400 of an instruction on the setting related to the multicast tree construction, for example, through the multicast tree setting packet 1.

The system configuration information management table 155 stores coupling ports and devices coupled by these coupling ports, for all the relay switches 200 and the virtual switches 400 constituting the network system 10A.

The server information management table 156 stores the tenant ID, the multicast address to be set as the destination address during the encapsulation, and the switch functioning as the virtual network termination unit, for each server.

The multicast tree configuration management table 157 stores the multicast address, as well as the relay switch 200 or the virtual switch 400 that transfers the multicast packet with the destination that is the multicast address, and the transfer port of the switch, in order to manage the multicast tree constructed on the network system 10A.

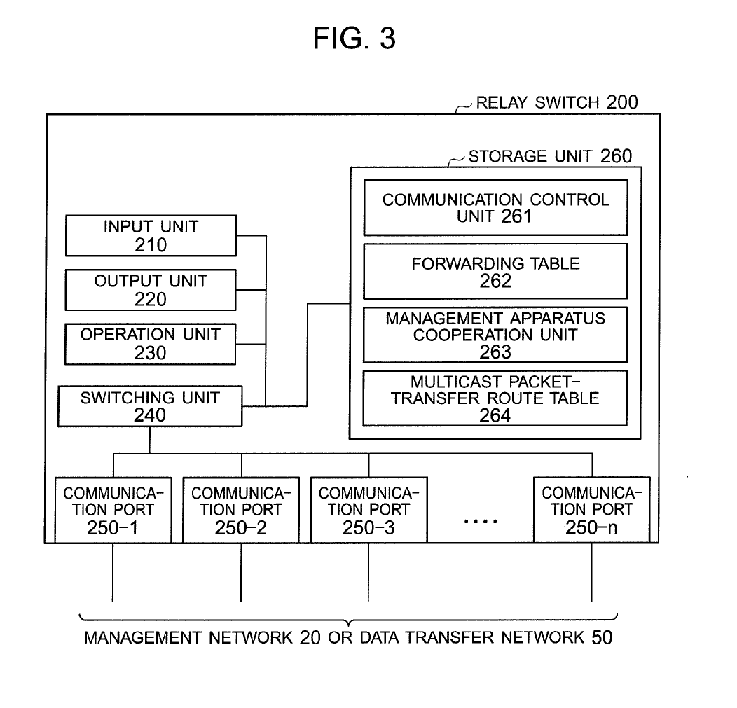

FIG. 3 is a diagram illustrating a functional configuration of the relay switch 200. The relay switch 200, for example, includes an input unit 210, an output unit 220, an operation unit 230, a switching unit 240, communication ports 250-1 to 250-n, and a storage unit 260. The communication ports 250-1 to 250-n are hereinafter referred to as “communication port 250” if they are not particularly distinguished from one another.

The input unit 210, for example, transmits user input information inputted from input devices such as a keyboard and a mouse, to the operation unit 230.

The output unit 220, for example, notifies an output device such as a display of output information for the user input.

The operation unit 230 executes an operating system, programs for realizing processing units to be described below, and the like, which are stored in the storage unit 260.

The switching unit 240 controls transmission, reception and the like of packets, for example, such as reception of a frame or a packet from the communication port 250, transmission of a frame or a packet to the communication port 250, and discard of a frame or a packet.

The communication port 250 is a coupling interface for communicating with other devices.

The storage unit 260, for example, stores the operating system (not shown); the programs for realizing the respective processing units such as a communication control unit 261 and a management apparatus cooperation unit 263; a forwarding table 262; and a multicast packet-transfer route table 264.

For example, if the destination address stored in the received packet has not been registered in the forwarding table 262, the communication control unit 261 registers a port that has received this packet, and a MAC address or an IP address that is set as a destination address of this packet, into the forwarding table 262. The communication control unit 261 also functions as the virtual network termination unit in the technique for constructing numerous logical networks, for example, by encapsulating or decapsulating the received frame.

Transfer port information on the frame or the packet based on the destination address (for example, the MAC address or the IP address) is recorded in the forwarding table 262 (detailed content is not shown), for example.

The management apparatus cooperation unit 263 receives the notification related to the multicast tree construction, which has been transmitted from the switch control unit 154 in the management apparatus 100, and executes the instruction in the notification. The management apparatus cooperation unit 263, for example, stores the transfer port for the multicast address included in the notification through the multicast tree setting packet 1, into the multicast packet-transfer route table 264.

The multicast packet-transfer route table 264 stores the transfer port for the multicast address.

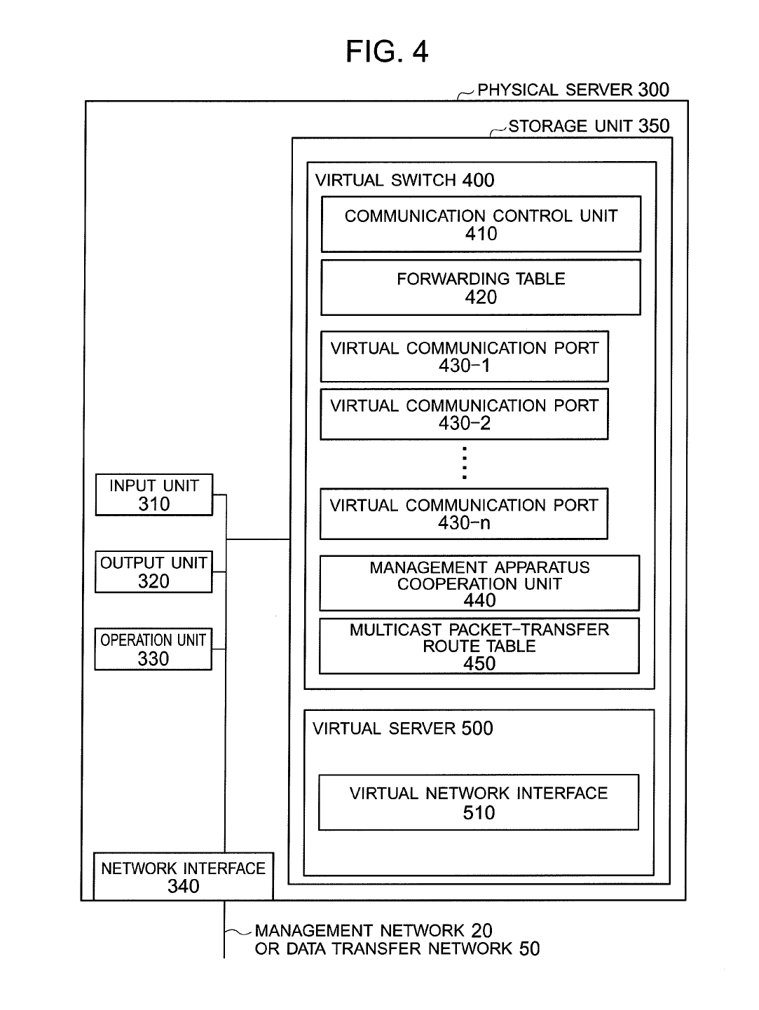

FIG. 4 is a diagram illustrating the physical server 300. The physical server 300, for example, includes an input unit 310, an output unit 320, an operation unit 330, a network interface 340, and a storage unit 350.

The input unit 310, for example, transmits user input information inputted from devices such as a keyboard and a mouse, to the operation unit 330.

The output unit 320, for example, notifies a device such as a display of output information for the user input.

The operation unit 330 executes an operating system and the like stored in the storage unit 350 to operate each processing unit, the virtual switch 400 and the virtual server 500.

The network interface 340 is, for example, configured with a device such as an NIC, and is coupled to other devices.

The storage unit 350 is, for example, a storage device such as a flash memory or an HDD, and for example, stores the operating system (not shown), the virtual switch 400 and the virtual server 500.

The virtual switch 400, for example, includes a communication control unit 410, a forwarding table 420, virtual communication ports 430a to 430n, a management apparatus cooperation unit 440, and a multicast packet-transfer route table 450. The virtual communication ports are hereinafter referred to as “virtual communication port 430” if they are not particularly distinguished from one another.

The communication control unit 410 controls transmission, reception and the like of packets, for example, such as reception of a frame or a packet from the network interface 340, transmission of a frame or a packet to the network interface 340, and discard of a frame or a packet. Moreover, for example, if the destination address stored in the received packet has not been registered in the forwarding table 420, the communication control unit 410 registers a port that has received this packet, and a MAC address or an IP address that is set as a destination address of this packet, into the forwarding table 420. The communication control unit 410 also functions as the virtual network termination unit in the technique for constructing numerous logical networks, for example, by encapsulating or decapsulating the received frame.

Virtual transfer port information on the packet based on the destination address (for example, the MAC address or the IP address) is recorded in the forwarding table 420 (detailed content is not shown), for example. The virtual communication port 430 is a coupling interface for communicating with other devices, for example, the network interface 340 and the virtual server 500.

The management apparatus cooperation unit 440 receives the notification related to the multicast tree construction, which has been transmitted from the switch control unit 154 in the management apparatus 100, and executes the instruction in the notification. The management apparatus cooperation unit 440, for example, stores the transfer port for the multicast address included in the notification through the multicast tree setting packet 1, into the multicast packet-transfer route table 450.

The multicast packet-transfer route table 450 stores the transfer port for the multicast address.

The virtual server 500 is a virtualized computer, and for example, includes a virtual network interface 510. Any operating system (not shown), application program (not shown) or the like operates on the virtual server 500.

The virtual network interface 510 is, for example, configured with a function such as a virtual MC, and is coupled to the virtual switch 400.

FIG. 5 is a diagram illustrating an example of the system configuration information management table 155 stored in the management apparatus 100.

IDs of the switches managed by the management apparatus 100, for example, the IDs of the relay switch 200 and the virtual switch 400 are stored in a managed switch ID column 155A. Identification numbers of coupling ports of the managed switches, for example, the identification numbers of the communication port 250 and the virtual communication port 430 are stored in a coupling port column 155B. The IDs of the switches coupled by the coupling ports, for example, the IDs of the relay switch 200 and the virtual switch 400 are stored in a coupled switch ID column 155C.

FIG. 5, for example, indicates that the relay switch 200a is coupled to the relay switch 200c via the communication port P2.

FIG. 6 is a diagram illustrating an example of the server information management table 156 stored in the management apparatus 100.

The IDs of the servers managed by the management apparatus 100 are stored in a server ID column 156A. The tenant IDs of the servers are stored in a tenant ID column 156B. The multicast address to be set as the destination address during the encapsulation of the frame transmitted by each server at the virtual network termination unit is stored in a multicast address column 156C. The switch including the virtual network termination unit that encapsulates the frame transmitted by each server is stored in a virtual network termination unit column 156D.

FIG. 6, for example, indicates that the virtual server 500a is a virtual server belonging to the tenant A, and that when the virtual server 500a transmits a multicast frame or a broadcast frame, the frame is encapsulated in a multicast packet with the destination address of 239.1.1.1, in the virtual switch 400a or the virtual switch 400b that is the virtual network termination unit. It should be noted that multiple entries for the virtual server 500a mean that the virtual server 500a moves. Each entry may be automatically stored by the management apparatus 100 during the movement of the virtual server, or may be manually stored by an administrator. Moreover, the address to be stored in the multicast address column 156C may be a MAC address, an IP address, or an address used by other multicasts.

FIG. 7 is a diagram illustrating an example of the multicast tree configuration management table 157 stored in the management apparatus 100.

The multicast address that may be the destination address during the encapsulation at the virtual network termination unit is stored in a multicast address column 157A. The ID of the relay switch 200 or the virtual switch 400 that transfers the multicast packet is stored in a switch ID column 157B. The identification number of the transfer port for transferring the multicast packet in the relay switch 200 or the virtual switch 400, for example, the identification number of the communication port 250 or the network interface 340 is stored in a transfer port column 157C.

FIG. 7, for example, indicates that a multicast tree for the multicast address of “239.1.1.1” is constructed on the communication ports P2 and P3 of the relay switch 200a; the communication ports P2 and P3 of the relay switch 200b; the communication ports P1, P2 and P3 of the relay switch 200c; the communication ports P1, P2 and P3 of the relay switch 200d; the virtual communication port vP1 of the virtual switch 400a; and the virtual communication port vP1 of the virtual switch 400c.

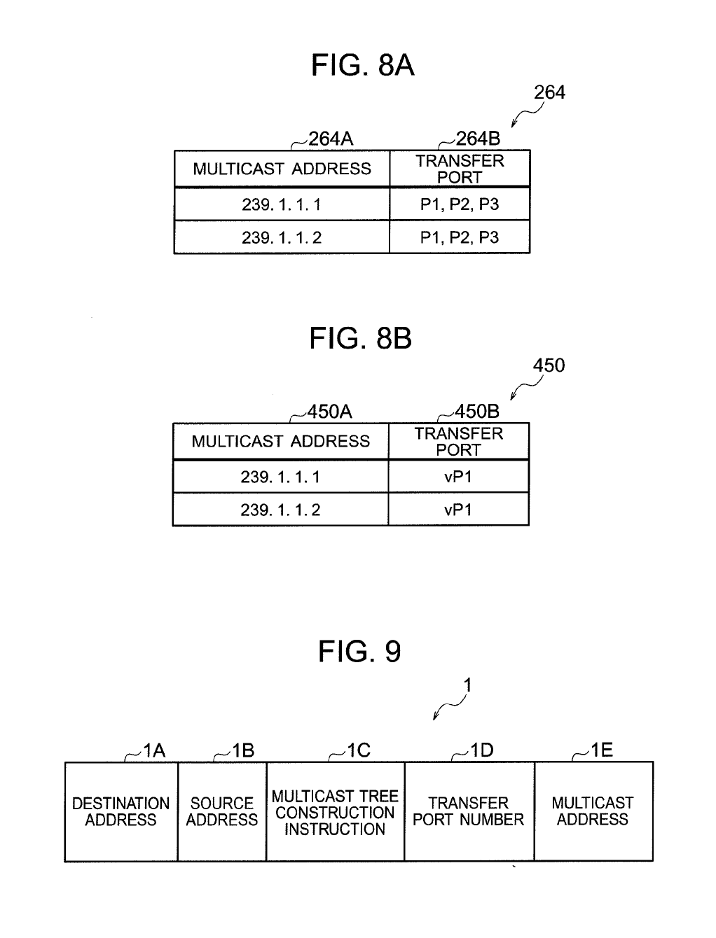

FIG. 8A illustrates the multicast packet-transfer route table 264 stored in the relay switch 200.

The multicast address is stored in a multicast address column 264A. The identification number of the port that transfers the multicast packet with the destination that is the multicast address stored in the multicast address column 264A, for example, the identification number of the communication port 250 is stored in a transfer port 264B.

FIG. 8A, for example, indicates that if the multicast packet with the destination address that is the multicast address of “239.1.1.1” is transferred according to a common multicast packet transfer rule, the multicast packet is transmitted from the communication ports other than the communication port that has received the multicast packet, in the communication ports P1, P2 and P3.

FIG. 8B illustrates the multicast packet-transfer route table 450 stored in the virtual switch 400. The multicast address is stored in a multicast address column 450A. The identification number of the port that transfers the multicast packet with the destination that is the multicast address stored in the multicast address column 450A, for example, the identification number of the virtual communication port 430 is stored in a transfer port 450B.

FIG. 9 is a diagram illustrating an example of the multicast tree setting packet 1 that is a packet used by the management apparatus 100 to notify the switch of the setting for constructing the multicast tree.

The MAC address of the switch to which the multicast tree is set, for example, is stored in a destination address field 1A. The MAC address of the management apparatus is stored in a source address field 1B. The instruction on the setting related to the multicast tree construction such as “add” or “delete” is stored in a multicast tree construction instruction field 1C. A transfer port number in which the instruction stored in the multicast tree construction instruction field 1C is reflected is stored in a transfer port number field 1D. The multicast address in which the instruction stored in the multicast tree construction instruction field 1C is reflected is stored in a multicast address field 1E.

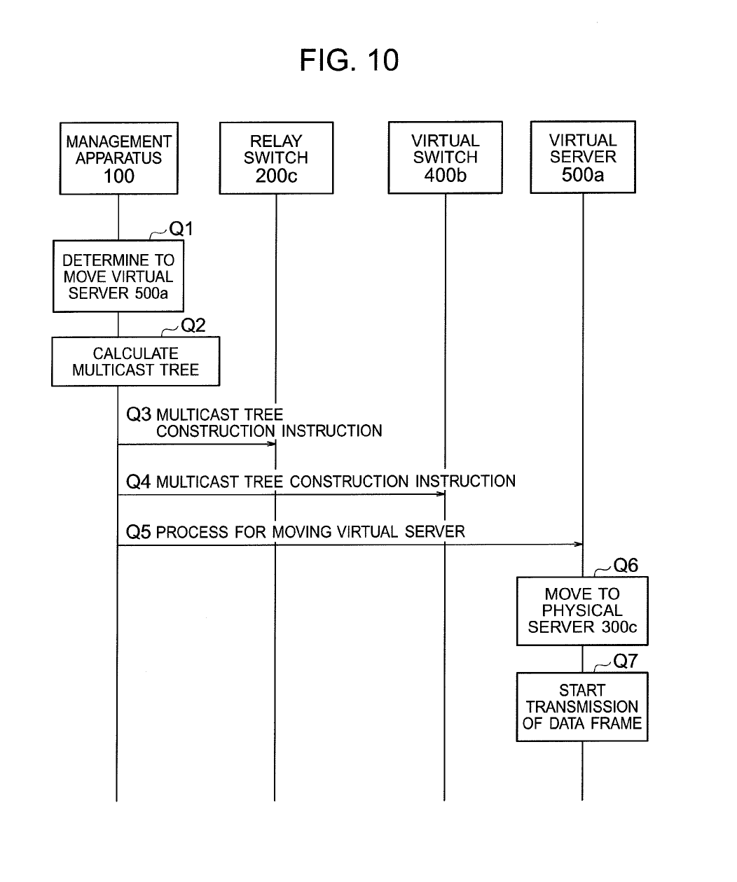

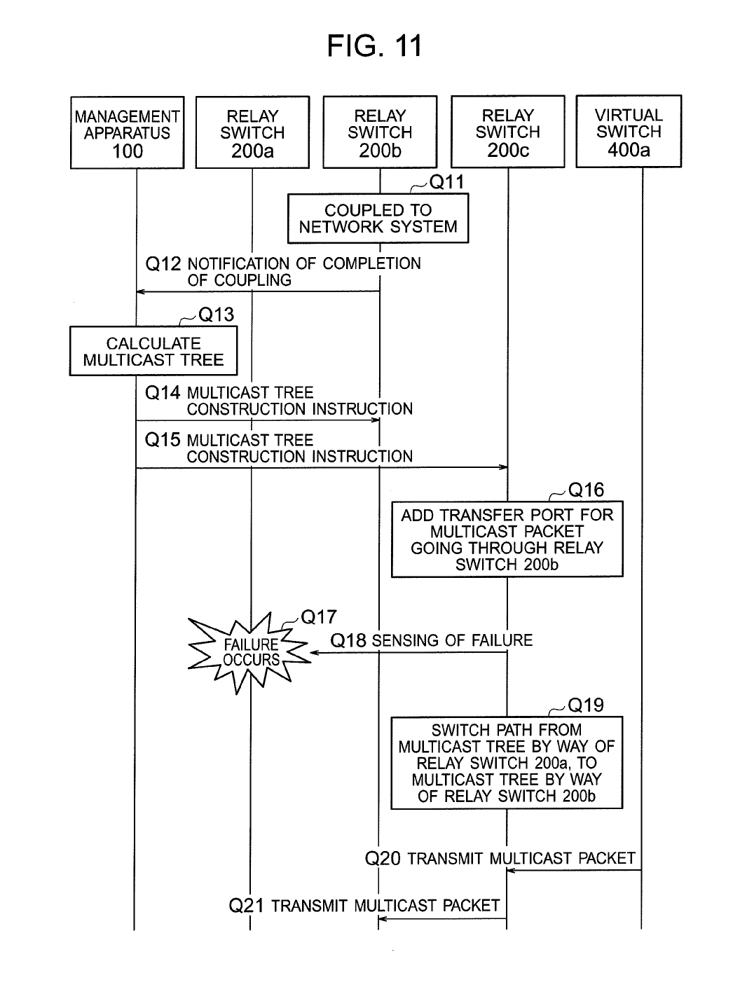

FIGS. 10 and 11 are sequence diagrams illustrating a multicast tree construction process in the first embodiment.

Sequences Q1 to Q7 of FIG. 10 illustrate a process in which, in the case where the virtual server 500a moves from the physical server 300a to the physical server 300b in the network system 10A of FIG. 1, the multicast packet-transfer route table 264 or the multicast packet-transfer route table 450 in each switch is updated, and the virtual server 500a completes the movement and starts data communication.

Unlike conventional environments, in the technique for constructing numerous logical networks, which is assumed in the present example, a receiver of data transferred via multicast communication and an end of a multicast tree are, for example, a server and a switch, respectively, which are different. For this reason, according to the present example, the multicast tree can be constructed on the switch of a move destination before the movement of the virtual server, as described below.

In sequence Q1, the management apparatus 100 determines to move the virtual server 500a from the physical server 300a to the physical server 300b, and stores new system configuration information into the system configuration information management table 155 and the server information management table 156. It should be noted that this determination may be performed by another management system (not shown), and the system configuration information management unit 151 of the management apparatus 100 may be notified of this determination.

In sequence Q2, the management apparatus 100 retrieves the multicast address to be set as the destination address during the encapsulation of the frame transmitted by the virtual server 500a at the virtual network termination unit, from the server information management table 156. The management apparatus 100 next uses the system configuration information management table 155 and the server information management table 156 to calculate the multicast tree for this multicast address so that the multicast tree is configured on the network coupling the virtual network termination units (that is, the virtual switch 400 and the relay switch 200e).

In sequence Q3, the management apparatus 100 transmits the multicast tree setting packet 1 to the relay switch 200c so that the communication port P4 is newly set as the transfer port for this multicast address, based on the calculated multicast tree. The multicast tree setting packet 1 includes the destination address field 1A of “the MAC address of the relay switch 200c,” the source address field 1B of “the MAC address of the management apparatus,” the multicast tree construction instruction field 1C of “add,” the transfer port number field 1D of “P4,” and the multicast address field 1E of “239.1.1.1.”

In sequence Q4, the management apparatus 100 transmits the multicast tree setting packet 1 to the virtual switch 400b so that the virtual communication port vP1 is newly set as the transfer port for this multicast address, based on the calculated multicast tree. In the multicast tree setting packet 1, “the MAC address of the virtual switch 400b” is stored in the destination address field 1A, “the MAC address of the management apparatus” is stored in the source address field 1B, “add” is stored in the multicast tree construction instruction field 1C, “vP1” is stored in the transfer port number field 1D, and “239.1.1.1” is stored in the multicast address field 1E.

In sequence Q5, the management apparatus 100, for example, uses a known technique to move the virtual server 500a to the physical server 300b.

In sequence Q6, the movement of the virtual server 500a to the physical server 300b is completed.

In sequence Q7, the virtual server 500a starts the transmission of the data frame.

It should be noted that while FIG. 10 describes the case where the virtual server 500 moves between the physical servers 300, a similar sequence diagram also applies to the case where the virtual server 500 is newly added to the physical server 300, or where the virtual server 500 is deleted from the physical server 300.

In the case where there are the management apparatus 100, the relay switch 200a, the relay switches 200c to 200e, and the physical servers 300a to 300d, and then the relay switch 200b is newly added in FIG. 1, sequences Q11 to Q21 of FIG. 11 illustrate a process for updating the multicast packet-transfer route table 264 or the multicast packet-transfer route table 450 in each switch, and a process for continuing multicast packet communication when a failure occurs in the relay switch 200a after the addition of the relay switch 200b.

It should be noted that, for simplicity, FIG. 11 focuses attention on the multicast address to be set as the destination address during the encapsulation of the frame transmitted by the virtual server 500a (not shown), into the multicast packet, at the virtual network termination unit in the virtual switch 400a, and describes processes in the relay switches 200a to 200c and the virtual switch 400a when the multicast tree for this multicast address is constructed.

In sequence Q11, the relay switch 200b is, for example, newly coupled to the relay switch 200c, the relay switch 200d and the management apparatus 100 via the network, according to an instruction from the management apparatus 100.

In sequence Q12, the relay switch 200b, for example, uses SNMP (Simple Network Management Protocol) to notify the management apparatus 100 of completion of coupling to the switches. This notification may be provided to the management apparatus 100 from another management system (not shown).

In sequence Q13, the management apparatus 100 retrieves and obtains the multicast address to be set as the destination address during the encapsulation of the frame transmitted by the virtual server 500a, at the virtual network termination unit, from the server information management table 156, and then calculates the multicast tree for this multicast address so that the multicast tree is configured on a new network to which the relay switch 200b has been added.

In sequence Q14, the management apparatus 100 transmits the multicast tree setting packet 1 to the relay switch 200b so that the communication ports P2 and P3 are newly added as the transfer ports for the multicast address to be set as the destination address during the encapsulation at the virtual network termination unit in the virtual switch 400a, based on the calculated multicast tree. In the multicast tree setting packet 1, “the MAC address of the relay switch 200b” is stored in the destination address field 1A, “the MAC address of the management apparatus” is stored in the source address field 1B, “add” is stored in the multicast tree construction instruction field 1C, “P2” and “P3” are stored in the transfer port number field 1D, and “239.1.1.1” is stored in the multicast address field 1E.

In sequence Q 15, the management apparatus 100 transmits the multicast tree setting packet 1 to the relay switch 200c so that the communication port P2 is newly added to the transfer ports for this multicast address, based on the calculated multicast tree. In the multicast tree setting packet 1, “the MAC address of the relay switch 200c” is stored in the destination address field 1A, “the MAC address of the management apparatus” is stored in the source address field 1B, “add” is stored in the multicast tree construction instruction field 1C, “P2” is stored in the transfer port number field 1D, and “239.1.1.1” is stored in the multicast address field 1E.

In sequence Q16, the relay switch 200c newly adds the communication port P2 that is the transfer port toward the relay switch 200b, to the multicast packet-transfer route table 264 based on the received multicast tree setting packet 1, in addition to the communication port P1 that is the transfer port toward the relay switch 200a and has already been stored as the transfer port for this multicast address.

In sequence Q17, a communication failure occurs in the communication port P2 and the communication port P3 of the relay switch 200a.

In sequence Q18, the relay switch 200c senses the failure in the relay switch 200a, for example, in the event of no periodic packet being received from the communication port P1 coupled to the relay switch 200a. It should be noted that notification of the failure in the relay switch 200a may be provided by another network management system (not shown).

In sequence Q19, the relay switch 200c deletes the communication port P1, which is the transfer port for the multicast packet and has been stored in the multicast packet-transfer route table 264, and switches the transfer port for the multicast packet with the destination address that is this multicast address, to the communication port P2.

In sequence Q20, the virtual switch 400a encapsulates the frame transmitted by the virtual server 500a (not shown), into the multicast packet, and transmits this multicast packet from the virtual communication port vP1 that is the transfer port stored in the multicast packet-transfer route table 450, to the relay switch 200c.

In sequence Q21, the relay switch 200c transmits this multicast packet from the communication port P2 that is the transfer port stored in the multicast packet-transfer route table 264, to the relay switch 200b.

It should be noted that while FIG. 11 describes the case where the relay switch 200 is newly added, a similar sequence diagram also applies to the case where the relay switch 200 is deleted, and where the virtual switch 400 is added or deleted.

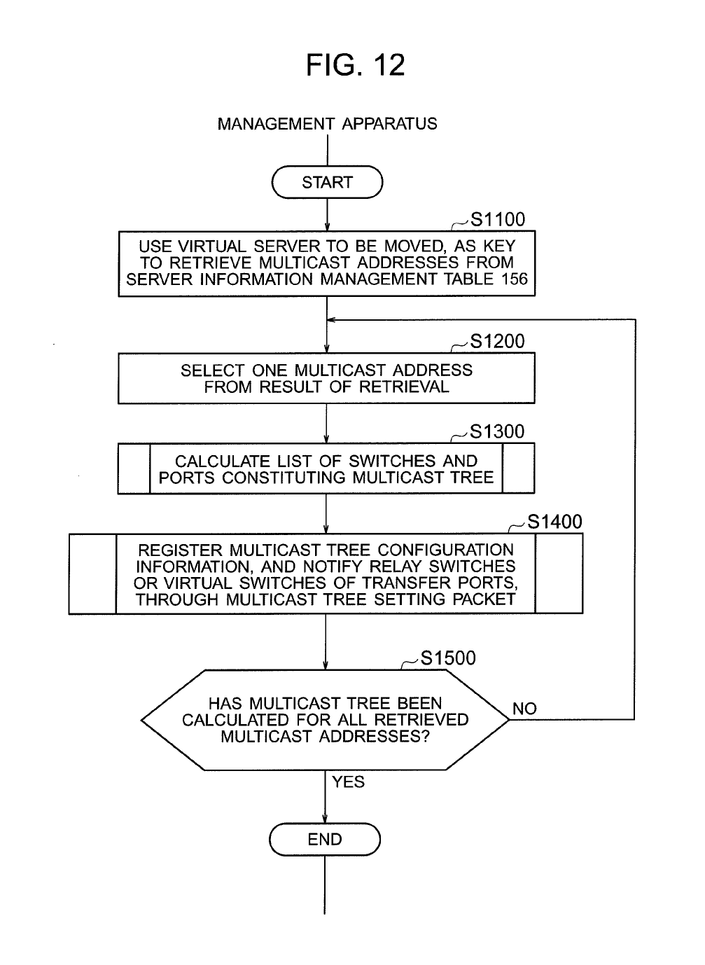

FIG. 12 is a flowchart illustrating sequences Q2 and Q3 in FIG. 10, that is, a processing procedure in the management apparatus 100 to calculate the multicast tree and to transmit the multicast tree setting packet 1 when the virtual server moves.

In step S1100, the management apparatus 100 uses the virtual server 500 that moves, as a key to retrieve the multicast addresses from the server information management table 156.

In step S1200, the management apparatus 100 selects one of the multicast addresses retrieved in step S1100, for which the multicast tree is constructed.

In step S1300, in order to construct the multicast tree for the multicast address selected in S1200, the management apparatus 100 uses the system configuration information management table 155 and the server information management table 156 to calculate a list of the transfer ports for the multicast packet with the destination address that is this multicast address, in each switch.

In step S1400, the management apparatus 100 registers the transfer ports of the switches included in the construction of the multicast tree, which have been calculated in step S1300, into the multicast tree configuration management table 157. The management apparatus 100 then transmits the multicast tree setting packet 1 to the switches constituting the multicast tree to notify them of the transfer ports.

In step S1500, the management apparatus 100 determines whether or not the multicast tree has been calculated for all the multicast addresses retrieved in step S1100. If the management apparatus 100 obtains a negative result from the determination in step S1500, the management apparatus 100 repeats step S1200. If the management apparatus 100 obtains a positive result from the determination in step S1500, the management apparatus 100 ends the process of FIG. 12.

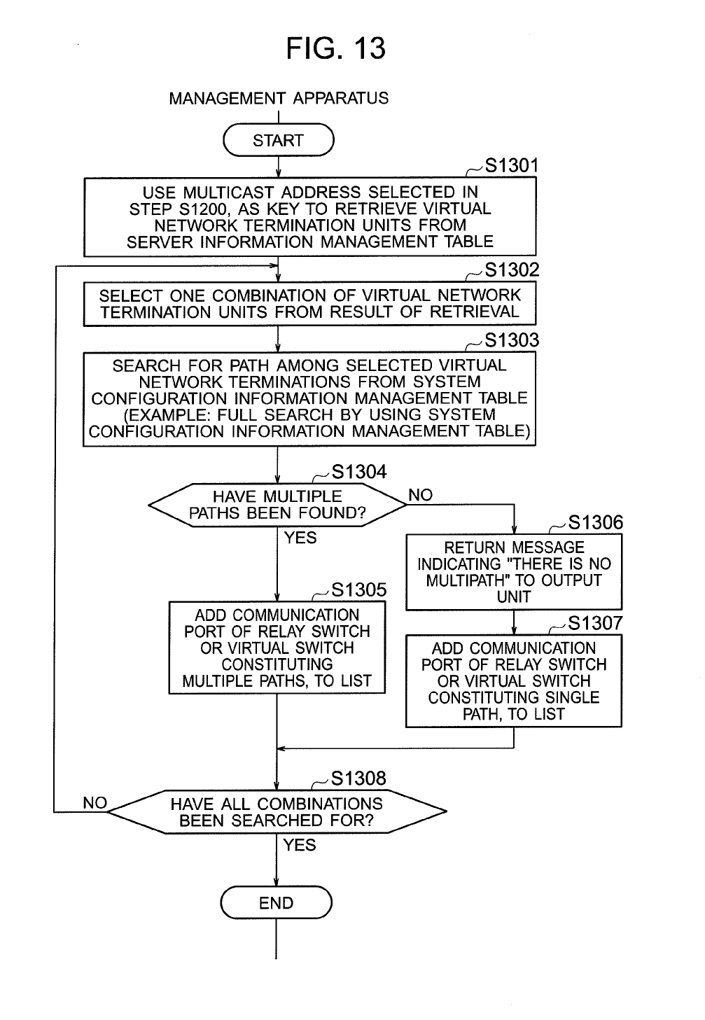

FIG. 13 is a flowchart illustrating step S1300 in FIG. 12, that is, a processing procedure in the management apparatus to calculate the transfer ports of each switch used for constructing the multicast tree.

In step S1301, the management apparatus 100 uses the multicast address selected in step S1200, as a key to retrieve the virtual network termination units from the server information management table 156.

In step S1302, the management apparatus 100 selects one combination of the virtual network termination units included in the construction of the multicast tree, from the virtual network termination units retrieved in S1301.

In step S1303, the management apparatus 100 performs full search for a path among the selected virtual network termination units, for example, by using the system configuration information management table 155. It should be noted that a known technique for calculating a path, such as IS-IS, may be used to identify this path.

The management apparatus 100, for example, sees the coupling configurations of the switches stored in the system configuration information management table 155 to search for paths between the virtual switch 400b and the virtual switch 400c. These paths are a path consisting of the virtual communication port vP1 of the virtual switch 400b, the communication ports P4 and P2 of the relay switch 200c, the communication ports P2 and P3 of the relay switch 200a, the communication ports P1 and P3 of the relay switch 200d, and the virtual communication port vP1 of the virtual switch 400c; and a path consisting of the virtual communication port vP1 of the virtual switch 400b, the communication ports P4 and P2 of the relay switch 200c, the communication ports P2 and P3 of the relay switch 200b, the communication ports P2 and P3 of the relay switch 200d, and the virtual communication port vP1 of the virtual switch 400c.

In step S1304, the management apparatus 100 determines whether or not multiple paths have been identified, that is, a multipath has been identified in step S1303. If the management apparatus 100 obtains a positive result from the determination in step S1304, the management apparatus 100 performs a process in step S1305. If the management apparatus 100 obtains a negative result from the determination in step S1304, the management apparatus 100 performs a process in step S1306.

The management apparatus 100 obtains the positive result from the determination in step S1304, and performs the process in step S1305, for example, because the path between the virtual switch 400b, to which the virtual server 500a on the physical server 300b after the movement is coupled, and the virtual switch 400c, to which the virtual server 500c is coupled, is the multipath including the path by way of the relay switch 200a and the path by way of the relay switch 200b, between the relay switch 200c and the relay switch 200d.

In step S1305, in order to enable the communication to be continued with another path, without reconstruction of the multicast tree in the case of a route failure, the management apparatus 100 adds the communication port 250 of the relay switch 200 or the virtual communication port 430 of the virtual switch 400, which constitutes the multipath, as the transfer port to the list so that one multicast tree for this multicast address is constructed on the multiple paths (routes), that is, on the multipath. It should be noted that, in the construction of the multicast tree on the multipath, the transfer ports may be added to the list so that the multicast tree may be configured on the entire multipath, or the transfer ports may be added to the list so that the multicast tree may be configured on a part of the multipath.

For example, in order to construct the multicast tree on the multipath between the virtual switch 400b, to which the virtual server 500a on the physical server 300b after the movement is coupled, and the virtual switch 400c, to which the virtual server 500c is coupled, the management apparatus 100 adds the virtual communication port vP1 of the virtual switch 400b, the communication ports P1 to P4 of the relay switch 200c, the communication ports P2 and P3 of the relay switch 200a, the communication ports P2 and P3 of the relay switch 200b, the communication ports P1 to P3 of the relay switch 200d, and the virtual communication port vP1 of the virtual switch 400c, to the list as the ports that performs transfer for this multicast address. Here, if the multicast packet from the virtual switch 400c to the tenant A is transferred to the virtual communication port vP1 of the virtual switch 400b, by way of the virtual communication port vP1 of the virtual switch 400c, the communication ports P3 and P1 of the relay switch 200d, the communication ports P3 and P2 of the relay switch 200a, and the communication ports P3 and P4 of the relay switch 200c, when a failure occurs in a communication route between the communication port P3 of the relay switch 200a and the communication port P1 of the relay switch 200d, the relay switch 200d switches the communication port used for transferring the packet, to the communication port P2 that is the transfer port for this multicast packet. The communication is thereby resumed to achieve quick recovery from the failure without the reconstruction of the multicast tree.

In step S1306, the management apparatus 100, for example, returns a message indicating “there is no multipath” to the output unit 120.

In step S1307, the management apparatus 100 adds the communication port 250 of the relay switch 200 or the virtual communication port 430 of the virtual switch 400, which constitutes a single path, as the transfer port to the list so that the multicast tree for this multicast address is constructed on the single path.

In step S1308, the management apparatus 100 determines whether or not the path has been search for, for all the combinations of the virtual network termination units retrieved in S1301. If the management apparatus 100 obtains a negative result from the determination in step S1308, the management apparatus 100 repeats the process in step S1302. If the management apparatus 100 obtains a positive result from the determination in step S1308, the management apparatus 100 ends the process of FIG. 13.

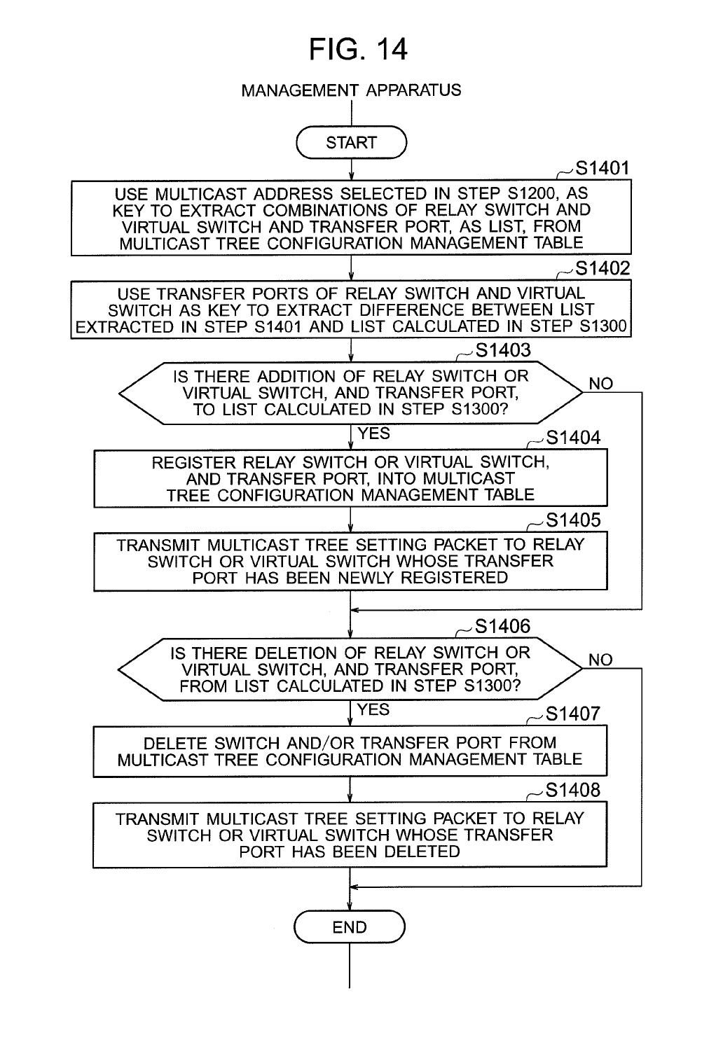

FIG. 14 is a flowchart illustrating step S1400 in FIG. 12, that is, a processing procedure to register the transfer ports of the switches included in the construction of the multicast tree, into the multicast tree configuration management table 157, and to use the multicast tree setting packet 1 to notify each switch of the transfer ports constituting the multicast tree.

In step S1401, the management apparatus 100 uses the multicast address selected in step S1200, as a key to extract combinations of the switch and the transfer port, as a list, from the multicast tree configuration management table 157.

In step S1402, the management apparatus 100 uses the transfer port of the switch as a key to extract a difference between the list extracted in step S1401 and the list calculated in step S1300.

In step S1403, the management apparatus 100 determines whether or not there is new addition of the relay switch 200 or the virtual switch 400, and the transfer port, to the list calculated in step S1300, as a result of the extraction in step S1402. If the management apparatus 100 obtains a positive result from the determination in step S1403, the management apparatus 100 performs a process in step S1404. If the management apparatus 100 obtains a negative result from the determination in step S1403, the management apparatus 100 performs a process in step S1406.

In step S1404, the management apparatus 100 registers the switch and the transfer port that have been newly added, into the multicast tree configuration management table 157.

In step S1405, the management apparatus 100 transmits the multicast tree setting packet 1 to the switch whose transfer port has been newly added in step S1404. In the multicast tree setting packet 1, the MAC address of the switch whose transfer port has been newly added is stored in the destination address field 1A. The MAC address of the management apparatus is stored in the source address field 1B. “Add” is stored in the multicast tree construction instruction field 1C. The transfer port added in step S1404 is stored in the transfer port number field 1D. The multicast address selected in step S1200 is stored in the multicast address field 1E.

In step S1406, the management apparatus 100 determines whether or not there is any switch or transfer port that has been deleted in the list retrieved in step S1401, as a result of the extraction in step S1402. If the management apparatus 100 obtains a positive result from the determination in step S1406, the management apparatus 100 performs a process in step S1407. If the management apparatus 100 obtains a negative result from the determination in step S1406, the management apparatus 100 ends the process of this figure.

In step S1407, the management apparatus 100 deletes the switch or the transfer port that has been deleted in the list retrieved in step S1401, from the multicast tree configuration management table 157.

In step S1408, the management apparatus 100 transmits the multicast tree setting packet 1 to the switch whose transfer port has been deleted, and ends the process of this figure. In the multicast tree setting packet 1, the MAC address of the switch having the transfer port deleted in step S1407 is stored in the destination address field 1A. The MAC address of the management apparatus 100 is stored in the source address field 1B. “Delete” is stored in the multicast tree construction instruction field 1C. The transfer port deleted in step S1407 is stored in the transfer port number field 1D. The multicast address selected in step S1200 is stored in the multicast address field 1E.

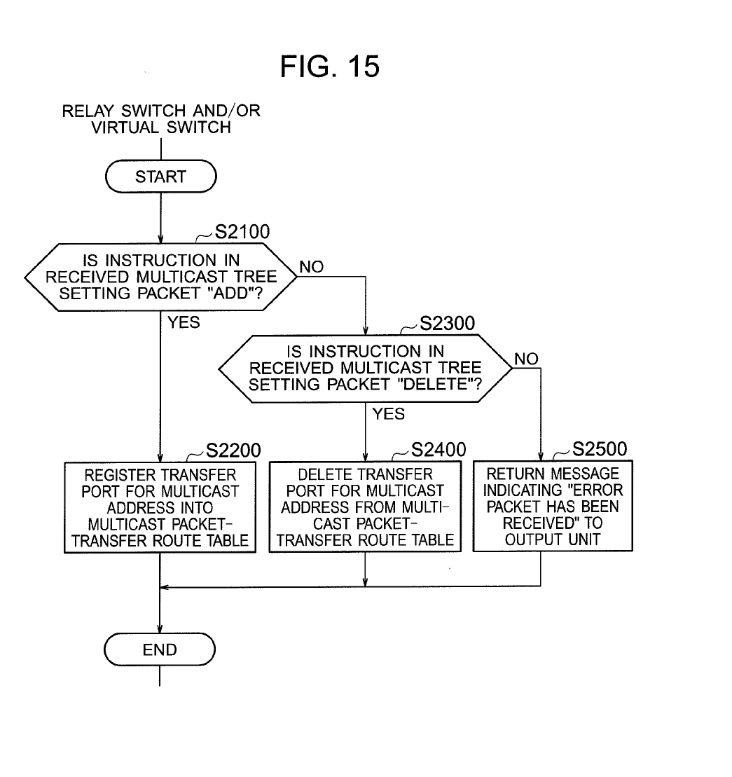

FIG. 15 is a flowchart illustrating a process in the relay switch 200c after sequence Q3 in FIG. 10, that is, a processing procedure in the switch to update the multicast packet-transfer route table 264 or the multicast packet-transfer route table 450.

In step S2100, the switch determines whether or not the multicast tree construction instruction field 1C of the received multicast tree setting packet 1 is “add.” If the switch obtains a positive result from the determination in step S2100, the switch performs a process in step S2200. If the switch obtains a negative result from the determination in step S2100, the switch performs a process in step S2300.

In step S2200, the switch registers the multicast address stored in the multicast address field 1E of the received multicast tree setting packet 1, and the transfer port number stored in the transfer port number field 1D, into the multicast packet-transfer route table 264 and/or the multicast packet-transfer route table 450, and ends the process of this figure.

In step S2300, the switch determines whether or not the multicast tree construction instruction field 1C of the received multicast tree setting packet 1 is “delete.” If the switch obtains a positive result from the determination in step S2300, the switch performs a process in step S2400. If the switch obtains a negative result from the determination in step S2300, the switch performs a process in step S2500.

In step S2400, the switch deletes the transfer port number stored in the transfer port number field 1D, for the multicast address stored in the multicast address field 1E of the received multicast tree setting packet 1, from the multicast packet-transfer route table 264 and/or the multicast packet-transfer route table 450, and ends the process of this figure.

In step S2500, the switch, for example, returns a message indicating “an error packet has been received” to the output unit 220 or the output unit 320, and ends the process of this figure.

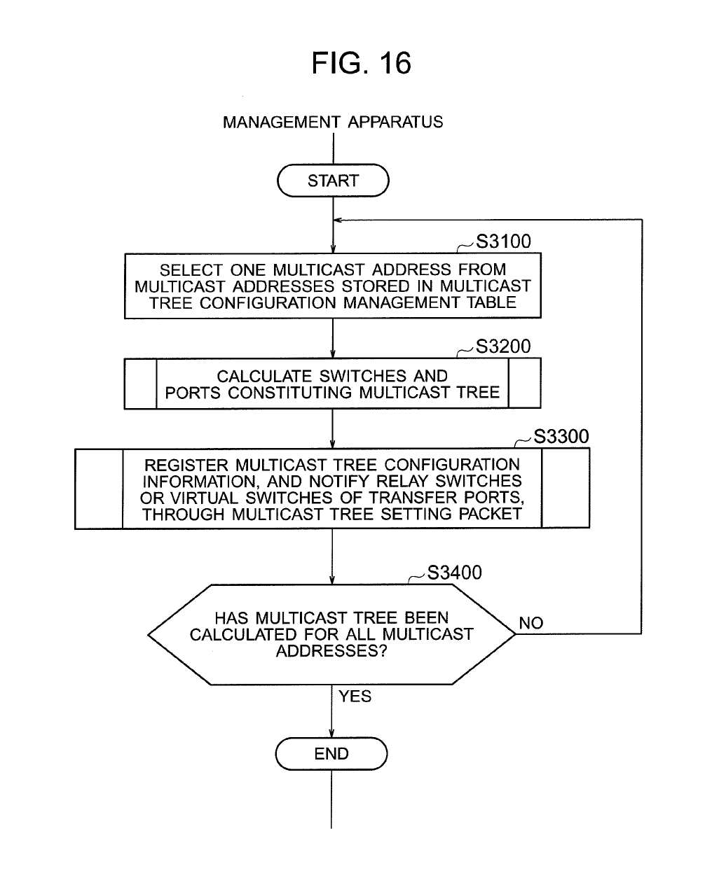

FIG. 16 is a flowchart illustrating sequences Q13 to Q15 in FIG. 11, that is, a processing procedure in the management apparatus 100 to calculate the multicast tree and to transmit the multicast tree setting packet 1 when the relay switch 200 is added.

In step S3100, the management apparatus 100 selects one multicast address from the multicast addresses stored in the multicast tree configuration management table 157.

In step S3200, in order to construct the multicast tree for the multicast address selected in S3100, the management apparatus 100 uses the system configuration information management table 155 and the server information management table 156 to calculate the transfer port in each switch. Details of step S3200 are similar to FIG. 13.

In step S3300, the management apparatus 100 registers the ports of the switches included in the construction of the multicast tree, which have been calculated in step S3200, into the multicast tree configuration management table 157. The management apparatus 100 then transmits the multicast tree setting packet 1 to the switches constituting the multicast tree to notify them of the transfer ports. Details of step S3300 are similar to FIG. 14.

In step S3400, the management apparatus 100 determines whether or not the multicast tree has been calculated for all the multicast addresses stored in the multicast tree configuration management table 157. If the management apparatus 100 obtains a negative result from the determination in step S3400, the management apparatus 100 repeats the process in step S3100. If the management apparatus 100 obtains a positive result from the determination in step S3400, the management apparatus 100 ends the process of FIG. 16.

As described above, according to the present embodiment, the multicast tree construction of a centralized management type enables the construction of the multicast tree on the multipath, and thus enables the communication to be resumed without the reconstruction of the multicast tree when a route failure occurs. Moreover, the management apparatus notifies the management apparatus cooperation unit in the relay switch or the virtual switch, of the setting of the multicast tree, through a switch management unit. This enables the construction of the multicast tree on the relay switch or the virtual switch under which no server exists. Accordingly, if the multicast tree has previously been constructed before the virtual server moves to another physical server, in consideration of the system configuration after such movement, the communication can be performed without constructing the multicast tree after the movement of the virtual server.

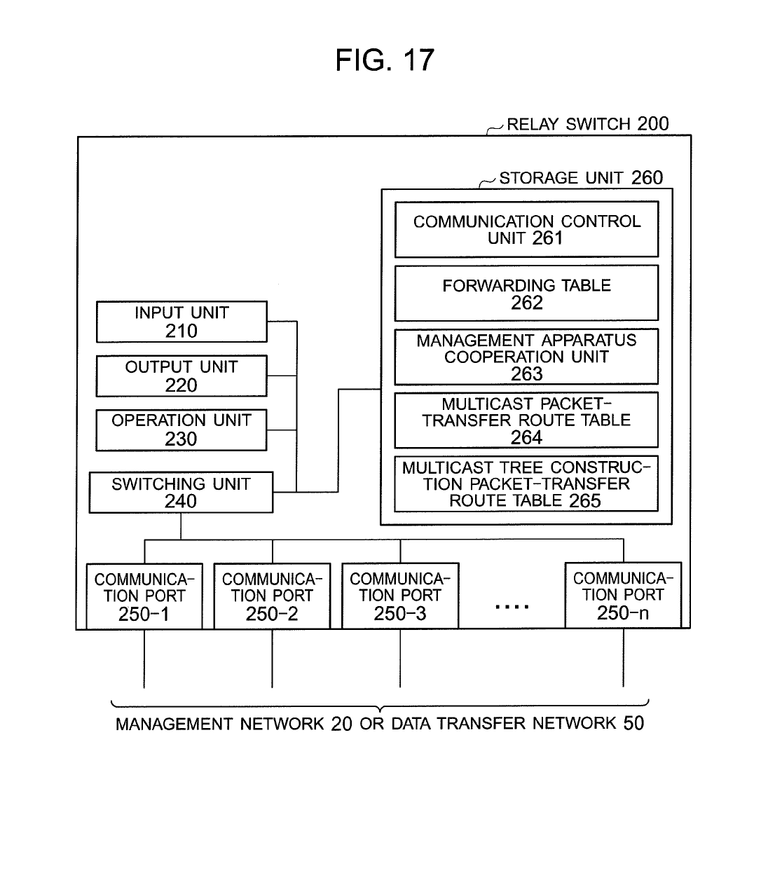

A second embodiment will be described with reference to FIGS. 17 to 26. The present embodiment corresponds to a variation of the first embodiment. Accordingly, differences from the first embodiment will be mainly described.

FIG. 1 generally illustrates a network system 10B according to the second embodiment.

FIG. 17 is a diagram illustrating an internal configuration of the relay switch 200. A difference from the first embodiment is a multicast tree construction packet-transfer route table 265 retained in the storage unit 260. The multicast tree construction packet-transfer route table 265 is a table for managing the communication port 250 that transfers a multicast tree construction packet, for example, a join request packet or a leave request packet in IGMP. The multicast tree construction packet-transfer route table 265 is updated based on the multicast tree construction packet-transfer route setting packet 2 transmitted from the management apparatus 100.

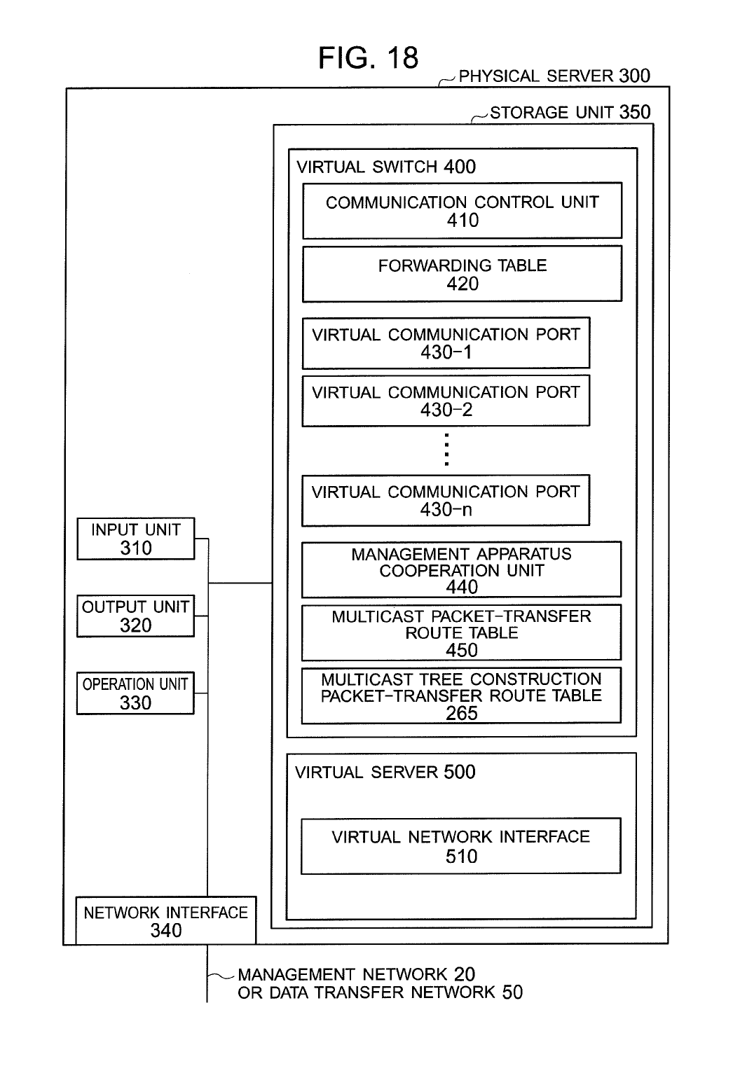

FIG. 18 is a diagram illustrating an internal configuration of the physical server 300. A difference from the first embodiment is a multicast tree construction packet-transfer route table 460 retained in the virtual switch 400. The multicast tree construction packet-transfer route table 460 is a table for managing the virtual communication port 430 that transfers the multicast tree construction packet, for example, the join request packet or the leave request packet in IGMP. The multicast tree construction packet-transfer route table 460 is updated based on the multicast tree construction packet-transfer route setting packet 2 transmitted from the management apparatus 100.

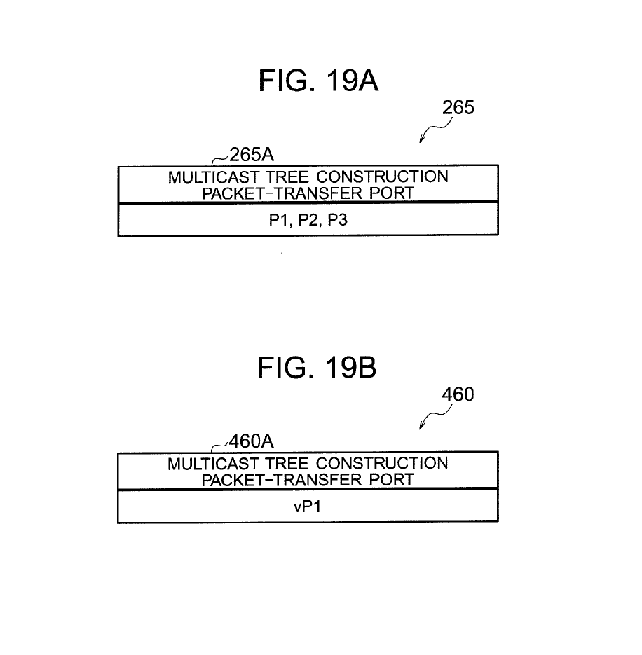

FIG. 19A illustrates the multicast tree construction packet-transfer route table 265 stored in the relay switch 200. FIG. 19B illustrates the multicast tree construction packet-transfer route table 460 stored in the virtual switch 400. The transfer port for transferring the multicast tree construction packet is stored in a multicast tree construction packet-transfer port column 265A and a multicast tree construction packet-transfer port column 460A.

FIG. 19A, for example, indicates that if the join request packet or the leave packet has been received for example, the relay switch 200 retaining the multicast tree construction packet-transfer route table 265 transfers this packet from the communication ports other than a communication port that has received this packet, in the communication ports P1, P2 and P3.

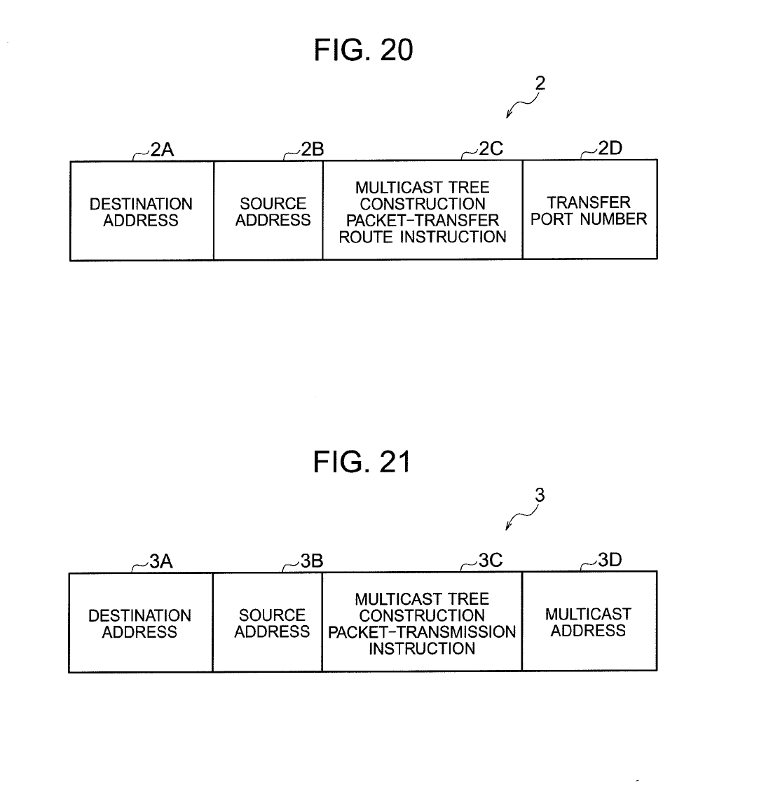

FIG. 20 is a diagram illustrating an example of the multicast tree construction packet-transfer route setting packet 2. The multicast tree construction packet-transfer route setting packet 2 is a packet used by the management apparatus 100 to instruct the switch to add or delete the port that transfers the multicast tree construction packet, for example.

The MAC address of the switch is stored in a destination address field 2A. The MAC address of the management apparatus is stored in a source address field 2B. The instruction on a transfer route for the multicast tree construction packet, for example, such as “add” or “delete,” is stored in a multicast tree construction packet-transfer route instruction field 2C. The transfer port number in which the instruction stored in the multicast tree construction packet-transfer route instruction field 2C is reflected is stored in a transfer port number field 2D.

FIG. 21 is a diagram illustrating an example of the multicast tree construction packet-transmission instruction packet 3. The multicast tree construction packet-transmission instruction packet 3 is a packet used by the management apparatus 100 to instruct the switch to transmit the join request packet or the leave request packet, for example.

The MAC address of the switch, for example, is stored in a destination address field 3A. The MAC address of the management apparatus, for example, is stored in a source address field 3B. The instruction on the type of the multicast tree construction packet, for example, such as “join request” or “leave request,” is stored in a multicast tree construction packet-transmission instruction field 3C. The multicast address of the multicast tree that performs the join or the leave is stored in a multicast address field 3D.

A multicast tree construction procedure in this configuration will be described next.

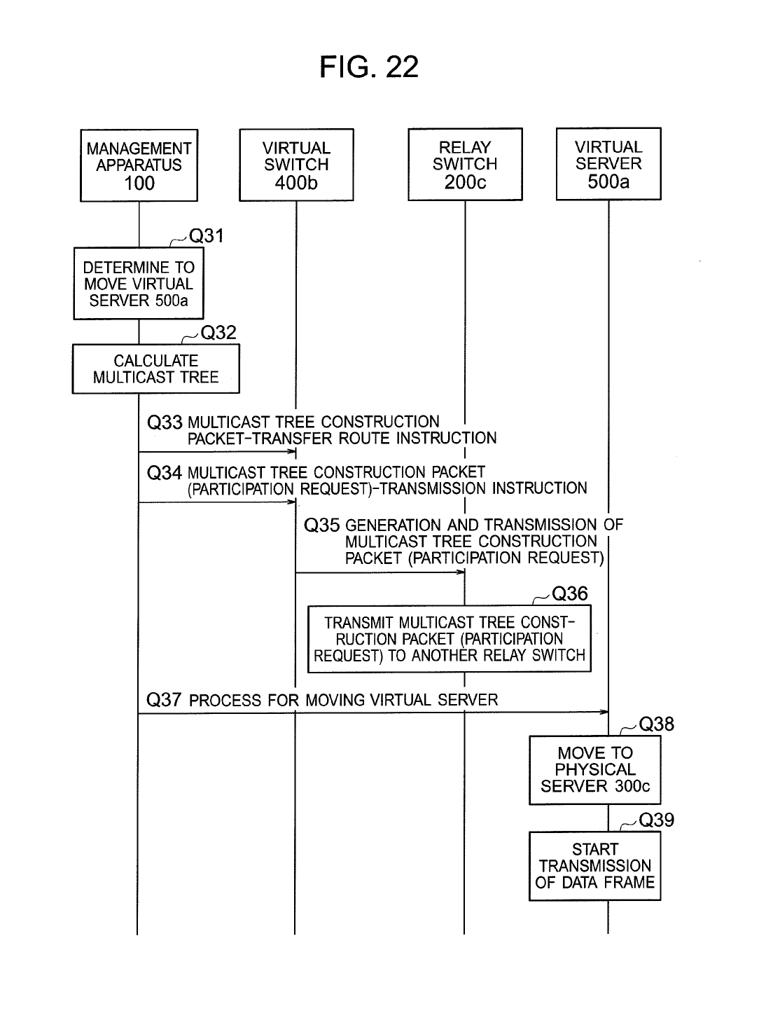

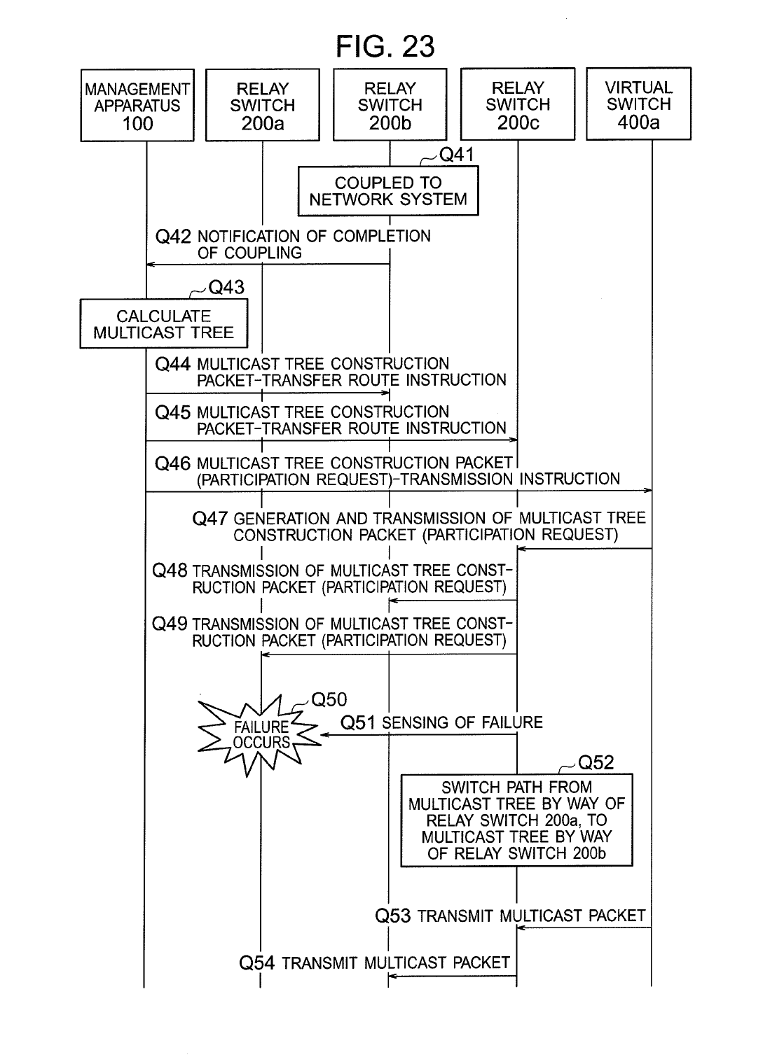

FIGS. 22 and 23 are sequence diagrams illustrating the multicast tree construction in the second embodiment.

Sequences Q31 to Q39 of FIG. 22 illustrate a process in which, in the case where the virtual server 500a moves from the physical server 300a to the physical server 300b in the network system 10B of FIG. 1, the multicast packet-transfer route table 264 or the multicast packet-transfer route table 450 in each switch is updated, and the virtual server 500a completes the movement and starts data communication.

Unlike conventional environments, in the technique for constructing numerous logical networks, which is assumed in the present example, a receiver of data transferred via multicast communication and an end of a multicast tree are, for example, a server and a switch, respectively, which are different. For this reason, according to the present example, the multicast tree can be constructed on the switch of the move destination before the movement of the virtual server, as described below.

Sequences Q31 and Q32 are similar to sequences Q1 and Q2 of the first embodiment in FIG. 10. Moreover, details of sequence Q32 are similar to the first embodiment, and are described in FIGS. 12 and 13.

In sequence Q33, the management apparatus 100 transmits the multicast tree construction packet-transfer route setting packet 2 to the virtual switch 400b so that the virtual communication port vP1 is newly set as the transfer port for the multicast tree construction packet, based on the calculated multicast tree. In the multicast tree construction packet-transfer route setting packet 2, “the MAC address of the virtual switch 400b” is stored in the destination address field 2A, “the MAC address of the management apparatus” is stored in the source address field 2B, “add” is stored in the multicast tree construction packet-transfer route instruction field 2C, and “vP1” is stored in the transfer port number field 2D. The management apparatus 100 may then not transmit the multicast tree construction packet-transfer route setting packet 2, for example, if the management apparatus 100 can confirm from the multicast tree configuration management table 157 that the multicast tree has been constructed on this virtual communication port, and that this virtual communication port has already been set as the transfer port for the multicast tree construction packet.

In sequence Q34, the management apparatus 100 transmits the multicast tree construction packet-transmission instruction packet 3 to the virtual switch 400b having the virtual network termination unit that manages the virtual server 500a after its movement, to instruct the virtual switch 400b to transmit the multicast tree construction packet. For example, in the multicast tree construction packet-transmission instruction packet 3, “the MAC address of the virtual switch 400b” is stored in the destination address field 3A, “the MAC address of the management apparatus” is stored in the source address field 3B, “participation request” is stored in the multicast tree construction packet-transmission instruction field 3C, and “239.1.1.1” is stored in the multicast address field 3D.

In sequence Q35, according to the instruction in the received multicast tree construction packet-transmission instruction packet 3, the virtual switch 400b, for example, uses the known technique IGMP to generate a “join request” packet with the multicast address of “239.1.1.1” that is the multicast tree construction packet, and transmits the packet to the relay switch 200c from the virtual communication port vP1 that has been learned as the transfer port for the multicast tree construction packet in sequence Q34. It should be noted that another known technique such as PIM (Protocol Independent Multicast), or a uniquely-defined protocol may be used for the multicast tree construction packet.

In sequence Q36, the relay switch 200c transfers the received multicast tree construction packet from the communication ports other than the communication port P4 that has received the multicast tree construction packet, in the transfer ports stored in the multicast tree construction packet-transfer route table 265.

In sequence Q37, the management apparatus 100 instructs the virtual server 500a to move to the physical server 300b.

In sequence Q38, the virtual server 500a moves to the physical server 300b.

In sequence Q39, the virtual server 500a starts the transmission of the data frame.

It should be noted that while FIG. 22 describes the case where the virtual server 500 moves between the physical servers 300, a similar sequence diagram also applies to the case where the virtual server 500 is newly added to the physical server 300, or where the virtual server 500 is deleted from the physical server 300.

In the case where there are the management apparatus 100, the relay switch 200a, the relay switches 200c to 200e, and the physical servers 300a to 300d, and then the relay switch 200b is newly added in the network system 10B of FIG. 1, sequences Q41 to Q54 of FIG. 23 illustrate a process for updating the multicast packet-transfer route table 264 or the multicast packet-transfer route table 450 in each switch. It should be noted that, for simplicity, FIG. 23 focuses attention on the multicast address to be set as the destination address during the encapsulation of the frame transmitted by the virtual server 500a (not shown), into the multicast packet, at the virtual network termination unit in the virtual switch 400a, and describes processes in the relay switches 200a to 200c and the virtual switch 400a when the multicast tree for this multicast address is constructed.

Sequences Q41 to Q43 are similar to sequences Q11 to Q13 of the first embodiment in FIG. 11. Moreover, details of sequence Q43 are similar to the first embodiment, and are described in FIG. 16.

In sequence Q44, the management apparatus 100 transmits the multicast tree construction packet-transfer route setting packet 2 to the relay switch 200b so that the communication ports P2 and P3 are newly set as the transfer ports for the multicast tree construction packet, based on the calculated multicast tree. In the multicast tree construction packet-transfer route setting packet 2, “the MAC address of the relay switch 200b” is stored in the destination address field 2A, “the MAC address of the management apparatus” is stored in the source address field 2B, “add” is stored in the multicast tree construction packet-transfer route instruction field 2C, and “P2” and “P3” are stored in the transfer port number field 2D.

In sequence Q45, the management apparatus 100 transmits the multicast tree construction packet-transfer route setting packet 2 to the relay switch 200c so that the communication port P2 is newly set as the transfer port for the multicast tree construction packet, based on the calculated multicast tree. In the multicast tree construction packet-transfer route setting packet 2, “the MAC address of the relay switch 200c” is stored in the destination address field 2A, “the MAC address of the management apparatus” is stored in the source address field 2B, “add” is stored in the multicast tree construction packet-transfer route instruction field 2C, and “P2” is stored in the transfer port number field 2D.

In sequence Q46, the management apparatus 100 transmits the multicast tree construction packet-transmission instruction packet 3 to all the switches having the virtual network termination units, to instruct them to transmit the join request packet. The management apparatus 100, for example, transmits the multicast tree construction packet-transmission instruction packet 3 to the virtual switch 400a to instruct it to transmit the join request packet. In the multicast tree construction packet-transmission instruction packet 3, “the MAC address of the virtual switch 400a” is stored in the destination address field 3A, “the MAC address of the management apparatus” is stored in the source address field 3B, “join request” is stored in the multicast tree construction packet-transmission instruction field 3C, and “239.1.1.1” is stored the multicast address field 3D.

In sequence Q47, according to the instruction in the received multicast tree construction packet-transmission instruction packet 3, the virtual switch 400a, for example, uses the known technique IGMP to generate the multicast tree construction packet, that is, the “join request” packet with the multicast address of “239.1.1.1,” and transmits the packet from the transfer port stored in the multicast tree construction packet-transfer route table 460. It should be noted that another known technique such as PIM (Protocol Independent Multicast), or a uniquely-defined protocol may be used for the multicast tree construction packet.

In sequences Q48 and Q49, the relay switch 200c, for example, uses the known technique IGMP to learn the transfer port for the multicast address in the multicast packet-transfer route table 264, from the received multicast tree construction packet. After the learning, the relay switch 200c transfers the received multicast tree construction packet from the communication ports other than the communication port P3 that has received the multicast tree construction packet, in the transfer ports stored in the multicast tree construction packet-transfer route table 265.

Sequences Q50 to Q54 illustrate a process for switching the multicast packet transfer port in the relay switch 200c, and a following process for transferring the multicast packet, in the case where a communication failure has occurred in the communication ports P2 and P3 of the relay switch 200a. The processes in sequences Q50 to Q54 are similar to sequences Q17 to Q21 of FIG. 11. It should be noted that while FIG. 23 describes the case where the relay switch 200 is newly added, a similar sequence diagram also applies to the case where the relay switch 200 is deleted, and where the virtual switch 400 is added or deleted.

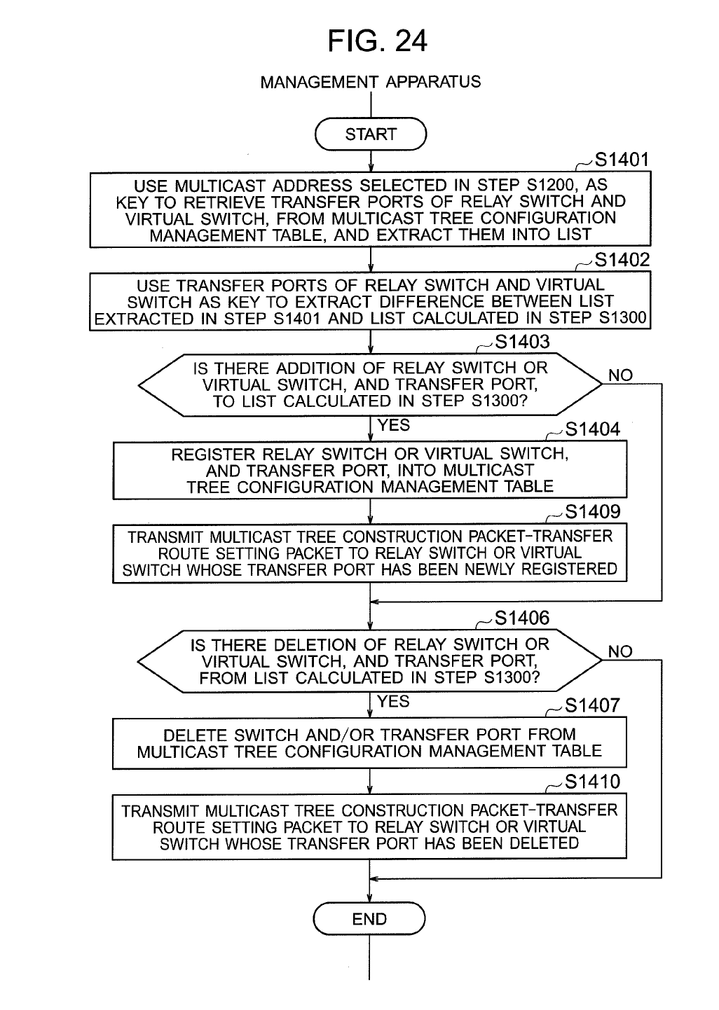

FIG. 24 is a diagram illustrating sequence Q33 of FIG. 22 and sequences Q44 and Q45 of FIG. 23, that is, a processing procedure in the management apparatus to transmit the multicast tree construction packet-transfer route setting packet 2.

Steps S1401 to S1404, S1406 and S1407 are similar to FIG. 14, and descriptions thereof will be omitted.

In step S1409, the management apparatus 100 transmits the multicast tree construction packet-transfer route setting packet 2 to the switch whose transfer port has been newly added in step S1404. The MAC address of the switch whose transfer port has been newly added is stored in the destination address field 1A of the multicast tree construction packet-transfer route setting packet 2. The MAC address of the management apparatus is stored in the source address field 1B. “Add” is stored in the multicast tree construction instruction field 1C. The transfer port added in step S1404 is stored in the transfer port number field 1D.

In step S1410, the management apparatus 100 transmits the multicast tree construction packet-transfer route setting packet 2 to the switch whose transfer port has been deleted, and ends the process of this figure. The MAC address of the switch having the transfer port deleted in step S1407 is stored in the destination address field 1A of the multicast tree construction packet-transfer route setting packet 2. The MAC address of the management apparatus 100 is stored in the source address field 1B. “Delete” is stored in the multicast tree construction instruction field 1C. The transfer port deleted in step S1407 is stored in the transfer port number field 1D.

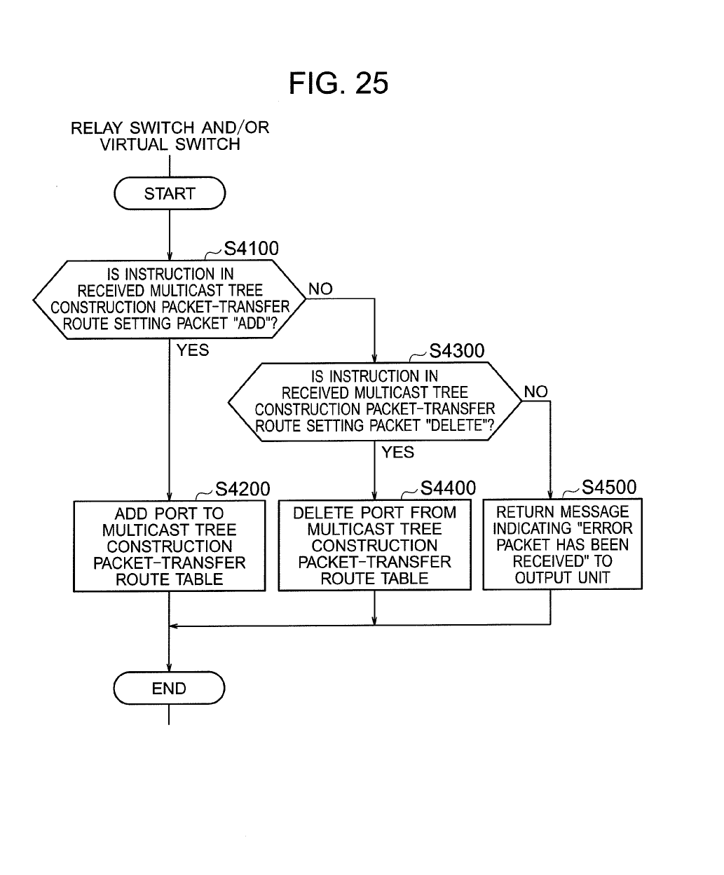

FIG. 25 is a flowchart illustrating sequence Q33 of FIG. 22 and sequences Q44 and Q45 of FIG. 23, that is, a processing procedure in the switch to update the multicast tree construction packet-transfer route table 265 or the multicast tree construction packet-transfer route table 460 when the switch has received the multicast tree construction packet-transfer route setting packet 2.

In step S4100, the switch determines whether or not the instruction in the multicast tree construction packet-transfer route instruction field 2C of the received multicast tree construction packet-transfer route setting packet 2 is “add.” If the switch obtains a positive result from the determination in step S4100, the switch performs a process in step S4200. If the switch obtains a negative result from the determination in step S4100, the switch performs a process in step S4300.

In step S4200, the switch adds the transfer port number stored in the transfer port number field 2D, to the multicast tree construction packet-transfer route table 265 or the multicast tree construction packet-transfer route table 460, and ends the process of FIG. 25.

In step S4300, the switch determines whether or not the instruction in the multicast tree construction packet-transfer route instruction field 2C of the received multicast tree construction packet-transfer route setting packet 2 is “delete.” If the switch obtains a positive result from the determination in step S4300, the switch performs a process in step S4400. If the switch obtains a negative result from the determination in step S4300, the switch performs a process in step S4500.

In step S4400, the switch deletes the port number stored in the transfer port number field 2D, from the multicast tree construction packet-transfer route table 265 or the multicast tree construction packet-transfer route table 460, and ends the process of FIG. 25.

In step S4500, the switch, for example, returns the message indicating “an error packet has been received” to the output unit 220 or the output unit 320, and ends the process of FIG. 25.

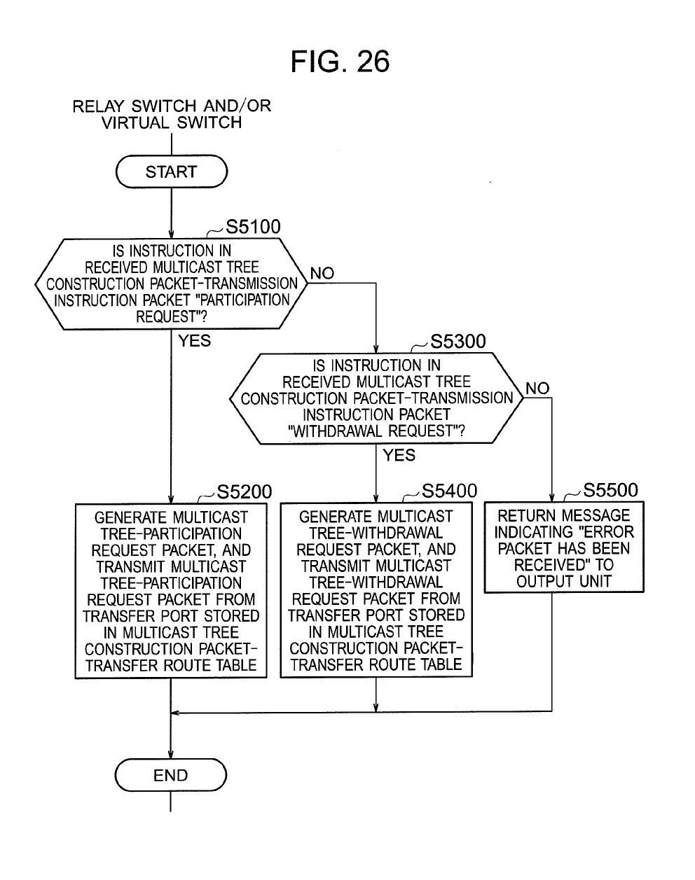

FIG. 26 is a flowchart illustrating sequence Q34 of FIG. 22 and sequence Q46 of FIG. 23, that is, a processing procedure in the switch to transmit the multicast tree construction packet when the switch has received the multicast tree construction packet-transmission instruction packet 3.

In step S5100, the switch determines whether or not the multicast tree construction packet-transmission instruction field 3C of the received multicast tree construction packet-transmission instruction packet 3 is “join request.” If the switch obtains a positive result from the determination in step S5100, the switch performs a process in step S5200. If the switch obtains a negative result from the determination in step S5100, the switch performs a process in step S5300.

In step S5200, the switch, for example, uses the known technique IGMP to generate a join request packet with respect to the multicast tree for the multicast address stored in the multicast address field 3D of the multicast tree construction packet-transmission instruction packet 3. The switch then transmits the packet from the transfer port stored in the multicast tree construction packet-transfer route table 265 or the multicast tree construction packet-transfer route table 460, and ends the process of FIG. 26.

In step S5300, the switch determines whether or not the multicast tree construction packet-transmission instruction field 3C of the received multicast tree construction packet-transmission instruction packet 3 is “leave request.” If the switch obtains a positive result from the determination in step S5300, the switch performs a process in step S5400. If the switch obtains a negative result from the determination in step S5300, the switch performs a process in step S5500.

In step S5400, the switch, for example, uses the known technique IGMP to generate a leave request packet with respect to the multicast tree for the multicast address stored in the multicast address field 3D of the multicast tree construction packet-transmission instruction packet 3. The switch then transmits the packet from the transfer port stored in the multicast tree construction packet-transfer route table 265 or the multicast tree construction packet-transfer route table 460, and ends the process of FIG. 26.

In step S5500, the switch, for example, returns the message indicating “an error packet has been received” to the output unit 220 or the output unit 320, and ends the process of FIG. 26.

As described above, according to the present embodiment, the multicast tree construction of the centralized management type using the known technique such as IGMP or PIM is enabled. Accordingly, if an existing switch is used as the relay switch 200, the multicast tree can be constructed on the multipath without the need for implementation of a new function.

The details of one or more implementations of the subject matter described in the specification are set forth in the accompanying drawings and the description below. Other features, aspects, and advantages of the subject matter will become apparent from the description, the drawings, and the claims.

We claim:

1. A management apparatus in a network system, the network system including a plurality of relay switches and a plurality of physical server apparatuses that are coupled via a network, and including a virtual server and a virtual switch that are configured on each of the physical servers, the virtual switch having a function of converting communication of the virtual server into multicast communication, the management apparatus being coupled to the relay switches and the physical server apparatuses via a management network, the management apparatus performing:
managing a coupling configuration of each virtual switch and each of the relay switches, a coupling configuration between each of the relay switches, and a coupling configuration of each virtual server and each virtual switch;
managing a multicast address to be set as a destination address when a frame transmitted by the virtual server is converted into a multicast packet at the virtual switch;
using the coupling configurations and the multicast address to obtain a setting that uses a plurality of routes for constructing one multicast tree on the network; and
notifying the virtual switch and/or the relay switch of the obtained setting for constructing the multicast tree.

2. The management apparatus according to claim 1, wherein the management apparatus performs:
before the virtual server is configured on the physical server, obtaining a setting for constructing a multicast tree to be newly constructed by the configuration of the virtual server; and
instructing the virtual switch and/or the relay switch to add the obtained setting.

3. The management apparatus according to claim 1, wherein the management apparatus performs:
if a new relay switch is added, obtaining a setting for constructing a new multicast tree by way of the added relay switch; and
instructing the virtual switch and/or the relay switch to add the obtained setting.

4. The management apparatus according to claim 1, wherein
the management apparatus specifies the multicast address, and a port that outputs the multicast packet with the destination address that is the multicast address, as the setting for constructing the multicast tree.

5. The management apparatus according to claim 1, wherein the management apparatus performs:
when notifying the virtual switch or the relay switch of a plurality of the settings for constructing the multicast tree, specifying a port that outputs a multicast tree construction packet; and
instructing the virtual switch constituting the multicast tree, and/or a relay switch having the function of converting the communication of the virtual server into the multicast communication, to transmit the multicast tree construction packet.

6. A relay switch that is coupled to a physical server via a network and constitutes a network system, the physical server including a virtual server and a virtual switch that are configured thereon, the virtual switch having a function of converting communication of the virtual server into multicast communication, the relay switch performing:
receiving a notification of a setting for constructing a multicast tree, from a management apparatus; and
executing an instruction on the setting.

7. The relay switch according to claim 6, wherein
if the management apparatus notifies the relay switch of a multicast address, and a port that outputs a multicast packet with a destination address that is the multicast address, the relay switch outputs the multicast packet with the destination address that is the multicast address, from the port in the notification.

8. The relay switch according to claim 6, wherein
if the management apparatus notifies the relay switch of a port that outputs a multicast tree construction packet, when the relay switch transfers the multicast tree construction packet that is received, the relay switch outputs the received multicast tree construction packet from the port in the notification.

9. The relay switch according to claim 8, wherein
if the management apparatus instructs the relay switch to transmit the multicast tree construction packet, the relay switch generates the multicast tree construction packet, and transmits the multicast tree construction packet from the port in the notification.

10. A virtual switch configured on a physical server that is coupled to a relay switch via a network and constitutes a network system, the virtual switch having a function of converting communication of a virtual server configured on the physical server, into multicast communication, the virtual switch performing:
receiving a notification of a setting for constructing a multicast tree, from a management apparatus; and
executing an instruction on the setting.

11. The virtual switch according to claim 10, wherein
if the management apparatus notifies the virtual switch of a multicast address, and a port that outputs a multicast packet with a destination address that is the multicast address, the virtual switch outputs the multicast packet with the destination address that is the multicast address, from the port in the notification.

12. The virtual switch according to claim 10, wherein
if the management apparatus notifies the virtual switch of a port that outputs a multicast tree construction packet, when the virtual switch transfers the multicast tree construction packet that is received, the virtual switch outputs the received multicast tree construction packet from the port in the notification, and
if the management apparatus instructs the virtual switch to transmit the multicast tree construction packet, the virtual switch generates the multicast tree construction packet, and transmits the multicast tree construction packet from the port in the notification.

13. A network system including a plurality of relay switches and a plurality of physical server apparatuses that are coupled via a network, and including a virtual server and a virtual switch that are configured on each of the physical servers, the virtual switch having a function of converting communication of the virtual server into multicast communication, the network system including a management apparatus coupled to the relay switches and the physical server apparatuses via a management network, wherein
the management apparatus performs:
managing a coupling configuration of each virtual switch and each of the relay switches, a coupling configuration between each of the relay switches, and a coupling configuration of each virtual server and each virtual switch;
managing a multicast address to be set as a destination address when a frame transmitted by the virtual server is converted into a multicast packet at the virtual switch;
using the coupling configurations and the multicast address to obtain a setting that uses a plurality of routes for constructing one multicast tree on the network; and
notifying the virtual switch and/or the relay switch of the obtained setting for constructing the multicast tree,
the relay switch performs:
receiving the notification of the setting for constructing the multicast tree, from the management apparatus; and
executing an instruction on the setting, and the virtual switch performs:
receiving the notification of the setting for constructing the multicast tree, from the management apparatus; and
executing the instruction on the setting.

14. The network system according to claim 13, wherein
the management apparatus performs:
before the virtual server is configured on the physical server, obtaining a setting for constructing a multicast tree to be newly constructed by the configuration of the virtual server; and
instructing the virtual switch and/or the relay switch to add the obtained setting.

15. The network system according to claim 13, wherein
the management apparatus performs:
if a new relay switch is added, obtaining a setting for constructing a new multicast tree by way of the added relay switch; and
instructing the virtual switch and/or the relay switch to add the obtained setting.

16. The network system according to claim 13, wherein
when the management apparatus notifies the virtual switch or the relay switch of the obtained setting for constructing the multicast tree, the management apparatus specifies the multicast address, and a port that outputs the multicast packet with the destination address that is the multicast address,
if the management apparatus notifies the relay switch of the multicast address, and the port that outputs the multicast packet with the destination address that is the multicast address, when the relay switch outputs the multicast packet with the destination address that is the multicast address, the relay switch transmits the multicast packet from the port in the notification, and
if the management apparatus notifies the virtual switch of the multicast address, and the port that outputs the multicast packet with the destination address that is the multicast address, when the virtual switch outputs the multicast packet with the destination address that is the multicast address, the virtual switch transmits the multicast packet from the port in the notification.

17. The network system according to claim 13, wherein
when the management apparatus notifies the virtual switch or the relay switch of the obtained setting for constructing the multicast tree, the management apparatus specifies a port that outputs a multicast tree construction packet, and instructs the virtual switch using the multicast communication, to transmit the multicast tree construction packet,
if the management apparatus notifies the relay switch of the port that outputs the multicast tree construction packet, when the relay switch transfers the multicast tree construction packet that is received, the relay switch transmits the received multicast tree construction packet from the port in the notification,
if the management apparatus notifies the virtual switch of the port that outputs the multicast tree construction packet, when the virtual switch transfers the multicast tree construction packet that is received, the virtual switch transmits the received multicast tree construction packet from the port in the notification, and
if the management apparatus instructs the virtual switch to transmit the multicast tree construction packet, the virtual switch generates the multicast tree construction packet, and transmits the multicast tree construction packet from the port in the notification.

18. The network system according to claim 17, wherein
if the management apparatus instructs the relay switch to transmit the multicast tree construction packet, the relay switch generates the multicast tree construction packet, and transmits the multicast tree construction packet from the port in the notification.
